(19) United States
(12) Patent Application Publication
(10) Pub. No.: US 2006/0087510 A1
(43) Pub. Date: Apr. 27, 2006

(54) Device and method of keyboard input and uses thereof

(76) Inventors: Nicoletta Adamo-Villani, Carmel, IN (US); Gerardo Beni, Riverside, CA (US)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 11/216,203

(22) Filed: Aug. 31, 2005

Related U.S. Application Data
(60) Provisional application No. 60/606,298, filed on Sep. 1, 2004.
(60) Provisional application No. 60/606,300, filed on Sep. 1, 2004.

(51) Int. Cl. G06T 13/00; G06T 15/70

(52) U.S. Cl. 345/474

(57) ABSTRACT

A method and system of configuring a three-dimensional model using a keyboard. A three-dimensional model is provided that is configurable about a plurality of degrees of freedom in which each respective degree of freedom is associated with a value representing a magnitude of movement from a neutral position. At least one key on a keyboard is associated with each respective degree of freedom of the three-dimensional model. In response to the selection of at least one key on the keyboard, identifying the respective degree of freedom associated with the keyboard selection and adjusting the value associated with the identified degree of freedom. Although keyboard based, this interface allows the user to obtain a desired configuration of the three-dimensional model without prior knowledge of any 3D software and without selecting and applying transformations using a graphical user interface.

### PRIORITY CLAIM

This application claims the benefit of U.S. Provisional Application No. 60/606,298, filed Sep. 1, 2004 and U.S. Provisional Application No. 60/606,300, filed Sep. 1, 2004, the entire disclosures of which are hereby incorporated by reference.

### BACKGROUND

1. Technical Field

The present invention relates to methods of computer programming and animation with applications in teaching.

2. Background Information

The control of human 3D model characters for animation is a complex problem which does not yet have a satisfactory answer. Controlling a human-like 3D character (or avatar) is difficult since the possible configurations of the character are described by a very high number of degrees of freedom (dof). Let's focus for instance on the most complex part in a human model: the hand (27 bones and >20 dof).

Accurate representation of hand configuration and motion is important to many areas such as: teaching signed communication, e.g., American Sign Language (ASL); communicative gestures in general, e.g., Human Computer Interface (HCI) visual recognition gestures, teaching dynamics manipulative tasks as, e.g., musical instrument playing, sport devices handling, tools handling; and teaching fine manipulative skills as, e.g., dentistry, surgery, defusing of explosive devices, and precision mechanics.

To accurately reproduce the almost infinite number of hand configurations and motions, the animator needs to control a large number of dof. She also needs a solid understanding of the mechanics of the hand as well as a deep knowledge of the 3D animation software.

Currently, the majority of 3t) character animation software packages offer Graphical User Interfaces (GUIs). Generally, once the skeleton has been created, the animator selects the individual joints and/or the Inverse Kinematics (IK) handles in the 3D scene and applies a series of transformations (rotations and translations) to attain a particular hand configuration.

Many 3D packages (such as Maya 6.0) allow the creation of customized Graphical User Interfaces for modelers and animators to facilitate and speed up the selection and transformation of the character's components. Typically, for character animation, the user points and click at joints and control handles at the exact body location on a static reference image in an ad hoc window. The motion of the joints is controlled by sliders included in another GUI window.

In Poser 5, (Poser 5 Handbook, Charles River Media, 2003), the user can select a hand configuration from the “hands library” and accept the pose completely or use it as a basis for making further modifications. In order to modify a particular library pose or to reach a hand configuration non-existent in the hands library, the user poses (rotates) each joint individually.

Even with a customized and user-friendly Graphic User Interface or with access to a large library of pre-made hand configurations, the process of configuring and animating the hand is tedious and time consuming because of the large number of joints and degrees of freedom (dof) involved. What is needed is a method for efficiently, rapidly, and accurately reconfiguring hands as represented in 3D animated simulations. Similarly there is a need for this type of configuration control for any 3D animated, simulated model which is articulated in a large (say, >10) degrees of freedom. For these complex models a method of representing, storing, and communicating (with low bandwidth) configurations and motions is also highly desirable.

### BRIEF SUMMARY

Our method can be applied to a variety of fields such as 2D illustrations rendering 3D objects, technical/medical animation, signed communication, and character animation.

The method that we present is not a GUI (Graphic User Interface) but a Keyboard User Interface (which we shall refer to as KUI for simplicity). Although keyboard based, this interface allows the user to obtain the desired hand configuration and animation without prior knowledge of any 3D software and without selecting and applying transformations (i.e., translations and rotations) to the individual joints.

This interface differs from traditional input-display methods. Traditionally, keyboard input results in alphanumeric display. Hot keys are used for specific actions but hot keys are not used systematically to produce graphic output. For example, even in the simplest drawing program, such as the one embedded in Microsoft Word, the user cannot draw with the keyboard. The interface for drawing is based on mouse input as are most graphic user interfaces.

In particular, for the configuration of 3D characters in modeling and animation, custom interfaces are often built to speed up the process of varying configurations. Such interfaces are also built on the basis of mouse input. A variant are motion capture input modes, in which case a motion capture suit (e.g., gloves) with sensors is used to input character configuration data (see e.g. http://www.metamotion.com/hardware/motion-capture-hardware-gloves-Cybergloves.htm).

The reason why in such applications the keyboard input is not used is primarily because the keyboard input is a discrete type of input while the graphic output to be controlled is generally continuous. For example, in drawing a straight line the possible angles span a continuum of values from 0 to 360 degrees. If the possible values of the angles were restricted to multiple of, say, 18 degrees, it would be possible to use 20 hotkeys to specify the angle. At the opposite extreme, one single hot key could be enough if the user were willing to hit the hotkey up to 20 times to reach the desired angle. It is clear that some intermediate number of hotkeys, e.g. four, would require the user a maximum of 5 key strokes to reach the desired angle.

This simple illustration contains the basic idea of the possibility of designing keyboard based interfaces for graphic output whenever discrete (quantized) values of the geometric parameters are acceptable. Continuous values can also be input by keyboard (as e.g. in resetting times in wrist watches which allow for continuous pressure on a key to quickly scan values) but for clarity we now focus on discrete steps input.

This is not an artificial or uncommon situation. In fact, discretization is widely used. Practically all 2D drawing programs, for example Microsoft Word, have the ‘snap to grid’ option while producing a drawing. The grid forces a discretization of the plane in which the figure is drawn so that the resulting geometric parameters are discretized. Such situations are indeed useful not only to improve the speed but also the accuracy of the drawing.

Similar advantages are offered by our method of discretizing the joint parameter values for the hand configuration so as to allow keyboard entry. Higher speed and accuracy of configuration can be achieved, as we discuss below.

In facing the problem of how to reconfigure one human hand for the purpose of signing the ASL fingerspelling alphabet, we reduced the problem to changing 26 dof. Because of this, it was then possible to map the 26 parameters to the 26 letters of the alphabet which can be conveniently typed via a keyboard input. Thus, by combining an appropriate choice of 26 motions with the convenience of the keyboard input, it was possible to control one hand of a human character; and this has been applied to ASL and manipulative tasks such as grasping.

In trying to extend the method beyond one hand, it was clear that controlling a whole human character was beyond the capabilities of the KUI method because of the very large number of dof.

A measure of efficiency in expressing meaning is provided by ‘semantic intensity’ which is defined, basically, as the ratio of the quantity of meaning conveyed to the quantity of effort required to convey it. Every image, in so far as it conveys meaning, and in so far as it requires some perceptual effort to be grasped, has a certain measure of semantic intensity.

The quantification of this intuitive concept is only recently begun. In any case it is possible to estimate an avatar from a semantic intensity point of view. A recent result is that a character composed only of head and hands has more semantic intensity than a full bodied avatar. Thus we are led to consider such ‘head and hands’ characters which are most efficient at conveying meaning.

The reduction of an avatar to only the head and hands provides a solution to the problem of an interface for controlling avatar configurations. In fact the KUI interface can be readily applied to right and left hand while the head and face provide a new but solvable challenge. In this patent we address this problem and devise a new set of dof for facial expression and head motion within the constraint of the 26 dof limit so that keyboard entry is convenient. Thus we have extended the KUI interface to the avatar and therefore, in their most significant aspect, to 3D human characters.

The KUI method of the present invention is effective and can be developed into a much more powerful technique by the use of a specialized reconfigurable keyboard, since the standard keyboard layout does not map intuitively onto the joints of the hand (See FIG. 1). There is a need for a hand shaped keyboard layout which is of simple realization and is reconfigurable into layout suitable for different joint structures to be controlled (e.g., hand gestures, facial expressions and head position-orientation).

### BRIEF DESCRIPTION OF THE DRAWINGS

FIG. 1 is an illustration of code-based hand-tool configuration;

FIG. 2 is an illustration of an example of code-based hand configurations for use in ASL;

FIG. 3 is an illustration of an example of keyframes in code-based ASL animation sequence illustrating the word “travel”;

FIG. 4 is an illustration of an example of a “hand configuration” window with code for the configuration;

FIG. 5 is an example of a “bookmarks” window with three examples of bookmarked configurations;

FIG. 6 is an illustration of an example of a process of setting keyframes using the “bookmarks” window;

FIG. 7 is an illustration of two standard skeletal setups for hand animation;

FIG. 8 is an illustration of the alphabet mapped to 26 degrees of freedom of the two standard skeletal setups of FIG. 7;

FIG. 9 is an illustration of a comparison between ASL hand shapes produced with an embodiment of the method of the present invention and the traditional 3-D software method;

FIG. 10 is an illustration of code-based ASL ten digit configurations;

FIG. 11 is an illustration of code-based animation of infant CPR;

FIG. 12 is an illustration of traditional keyframe animation of infant CPR;

FIG. 13 is an illustration of a code-based hand configuration and animation in low clearance and occluded areas;

FIG. 14 is an illustration of a skeletal structure of a hand with its 26 joints and an IK end-effector;

FIG. 15 is an illustration of a hand with letters of the alphabet located at the 26 joints of the hand;

FIG. 16 is an illustration of a hand and the code encoding for the “d” handshape;

FIG. 17 is an illustration of six pre-grasp configurations;

FIG. 18 is an illustration of a “hand configuration” window;

FIG. 19 is an illustration of an “animation” window;

FIG. 20 is an illustration of animation of five grasp and release created with a KUI interface of the present invention;

FIG. 21 is an illustration of a “pose library” window;

FIG. 22 is an illustration of animation of grasping a dental instrument;

FIG. 23 is an illustration of mapping letters to the hand joints on the left and a concept of a 3D model of a hand shape keyboard, in the center, and a data hand keyboard on the right;

FIG. 24 is an illustration of keyboard layout for input of hand gestures on the left, on the right is a keyboard layout for input of facial expressions;

FIG. 25 is an illustration identifying 22 facial regions;

FIG. 26 is an illustration of 22 facial joints on the left and mapping of letters to the 26 degrees of freedom of the face on the right;

FIG. 27 is an illustration six basic facial expressions;

FIG. 28 is an illustration of the location of joints corresponding to 16 articulators;

FIG. 29 is an illustration of facial deformation induced by articulator 2;

FIG. 30 is an illustration of a configuration window;

FIG. 31 is an illustration of an “animation” window;

FIG. 32 is an illustration of an avatar with only the head and hands;

FIG. 33 is a series of poses showing a signer signing a math question and its answer;

FIG. 34 is an illustration of an avatar with only the head and hands signing a math question and its answer;

FIG. 35 is an illustration of an avatar;

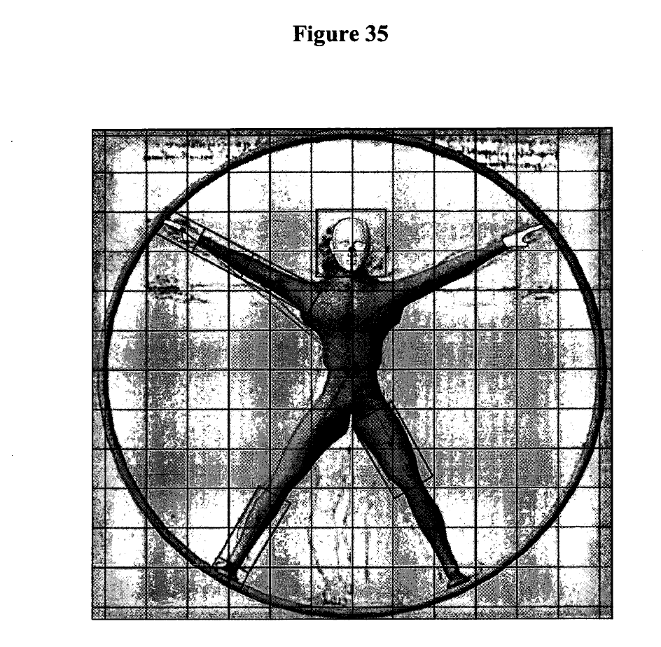

FIG. 36 is an illustration of an avatar segmented into components,

FIG. 37 is a photograph of a pantomime dancer; and

FIG. 38 is a photograph of a pantomime showing semantic intensity concentrated in the hands and face.

### DETAILED DESCRIPTION OF THE DRAWINGS AND THE PRESENTLY PREFERRED EMBODIMENTS

In character animation it is very important to capture and clearly convey the expressiveness of the hands. Typically, to facilitate the animation process, the animator uses reactive animation or expressions to create a series of user-defined attributes which drive the rotations of the hand joints. Examples of these standard attributes are finger curl, finger spread, pinky cup, fist, etc. While these attributes alleviate the animator of the tedious task of individually selecting and manipulating the hand joints, their creation is time consuming and requires software expertise. Usually a limited number (8-10) of custom hand configurations is produced for each character. In the majority of the cases, the user-defined attributes are used to bring the character's hand into a configuration that is close to the desired one. The animator is still required to manually select and rotate the joints to tweak the hand pose.

Our method allows the user to reach any hand configuration with just a few keystrokes, no user-defined attributes are required. Moreover, each configuration thus obtained is automatically recorded with a simple alphanumeric code. The code represents with letters the corresponding joint being moved (opposite directions correspond to upper and lower cases) and with numbers the corresponding number of steps in the motion. Also, because of the simplicity of the method, the user can easily create a large library of code-based hand configurations for each character. The codes, stored in a text file, can be easily loaded into the 3D scene and applied to a variety of characters when needed.

A 2D artist can quickly produce a large number of hand poses, apply them to different hand models (as explained below, our method can be used with any hand model rigged with a standard skeletal setup) and produce 2D images to be used in many applications such as technical illustration, multimedia and web content production, 2D animation, signed communication.

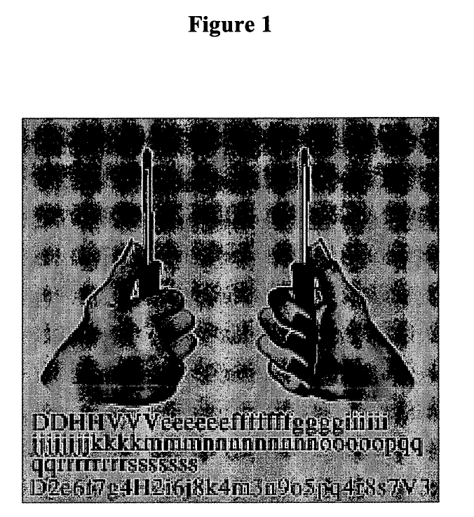

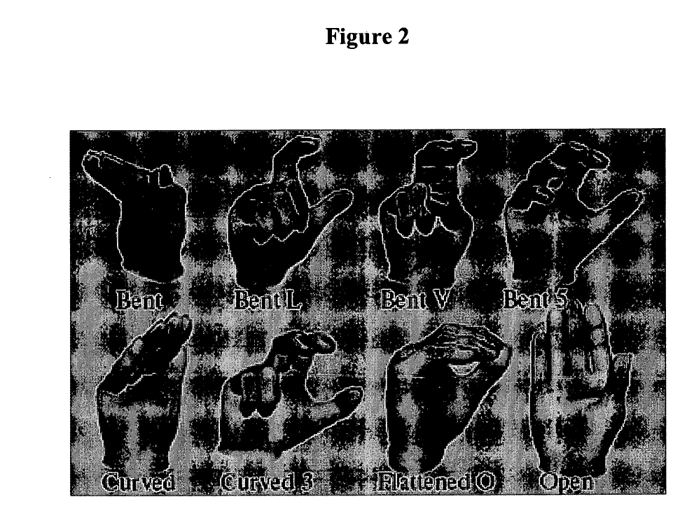

FIG. 1 shows a 2D image of a code-based hand-tool configuration captured from 2 different points of view along with the raw code (in the first three lines), which is a description of the actual strokes used to reach the configuration in a particular case, and the compacted code (in the last line) which is the representation of the final configuration obtained. The compacted code is produced automatically by the software as explained below. FIG. 2 shows 2D images of 8 basic hand configurations for ASL. Table 1 contains the relative compacted codes.

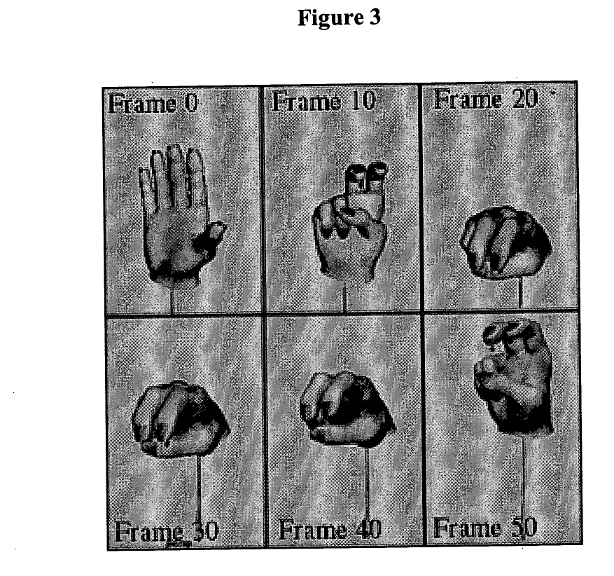

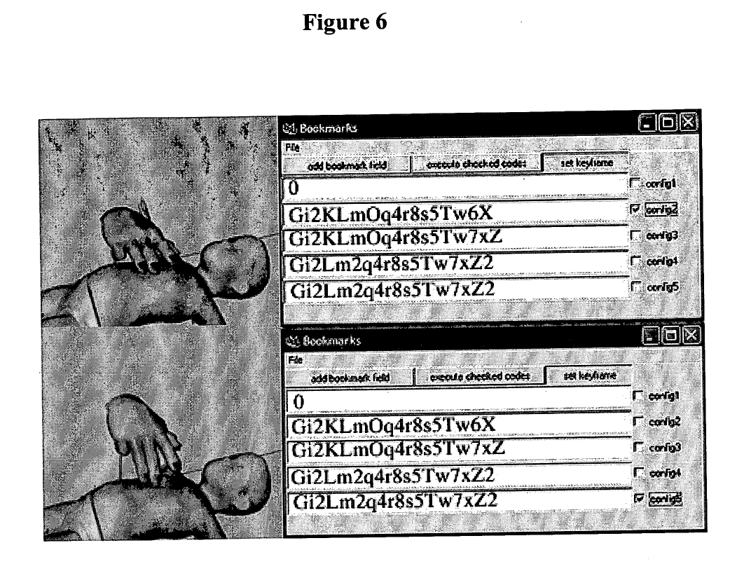

Our method not only allows the user to quickly configure the hand, but also to animate it with high level of realism. Because of its ease, speed and accuracy, our method can be used to quickly produce complex technical animations such as the medical animation illustrated in FIG. 6 and the ASL sequence illustrated in FIG. 3 representing the animation of the sign “travel”.

TABLE 1
“Compact” codes corresponding to 8 basic ASL configurations.

| Configuration | Code |
|---|---|
| Bent | a2bcD4g5Hk5o5ps5TU2 |
| Bent L | ABe5f3i4j9k5m6n8o6pq7r8s6T2U2 |
| Bent 5 | ad2e6f2g3hi5j3k2lm4n3o3pq2r5s4u |
| Bent V | a4b4c3de4f4gi4j5km4n9o6q4r9s6T2u2 |
| Curved | b2cD3g4Hk4o4ps4u2 |
| Curved 3 | a4de5f3gi5j4km5n9o5q5r9s5Tu2vw |
| Flattened O | a4bc2d2e4f5g3Hi2j6k3m2n4o4pqr4s4u2 |
| Open | abcD4Hpt2 |

As mentioned, our method is based on the realization that the hand has 26 degrees of freedom which can be controlled by the 26 letters of the English alphabet. Via keyboard input the hand can be positioned in space and manipulated to attain any configuration: by touching a letter key the user rotates the corresponding hand joint a pre-specified number of degrees around one of the three cardinal axes.

The HCI (Human Computer Interface) of this method, being based on keyboard entry, is graphically very simple. It consists of only two windows: (1) the “Hand Configuration” window, which is used to position and configure the hand, and (2) the “Bookmarks” window, which is used to animate the hand.

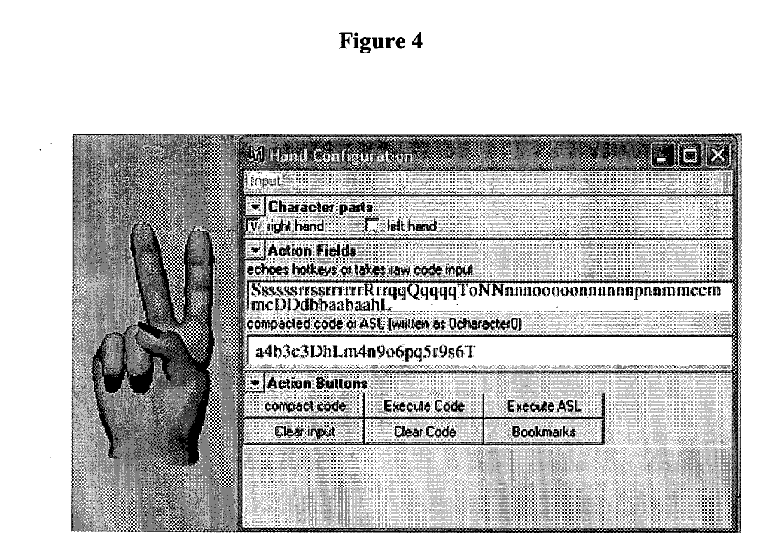

The “Hand Configuration” window (FIG. 4) has three collapsible frame layouts: (1) the “Character Parts” frame; (2) the “Action Fields” frame; and (3) the “Action Buttons” frame.

The upper frame is used to select the character part. In the embodiment illustrated here only hands are selectable and the right hand only is operational (checked box in FIG. 4). More complete embodiments are described later.

The middle frame consists of two fields: the upper field echoes the hotkeys used to configure the hand (it can also be used to type in code in any form, raw or compacted, sorted or not); the lower field contains compacted code (that is code that is in the standard form as described briefly above and in more detail below. See also FIG. 1, last line).

The third frame contains six buttons: (1) the upper-left button compacts the code (in raw or unsorted form) in the upper field and writes it in the lower field. (2) the upper-middle button executes the compacted code in the lower field (the hand will reconfigure itself accordingly and the reconfiguration is relative to the neutral position (see FIG. 4 on the left side). (3) The upper-right button executes ‘ASL code’ written in the lower field. ‘ASL code’ refers to fingerspelling hand configurations of ASL. To detect the ASL configurations we write the letters between zeros. Thus, for example, OBO corresponds to the configuration of the ASL letter B. If the lower field contains code of the form 0character0 it will interpret as ASL and the button execute ASL will configure the hand in the corresponding fingerspelling shape. (4) The lower-left and (5) lower-middle buttons simply clear the upper and lower fields respectively. (6) The lower right button opens the “Bookmarks” window.

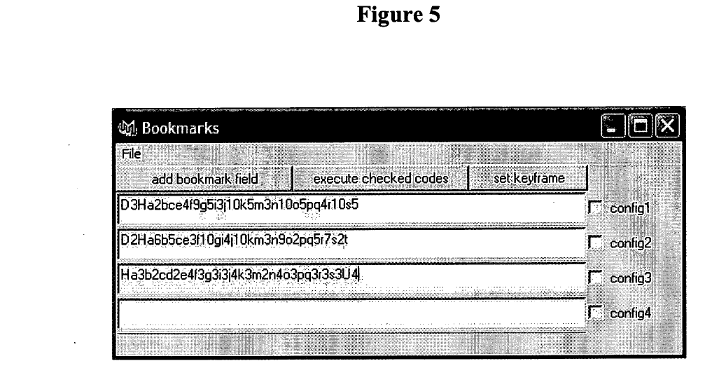

The “Bookmarks” window (represented in FIG. 5) is opened by the “Bookmarks” button in the “Hand Configuration” window. The window “Bookmarks” consists of a “File” menu, three buttons and an arbitrary number of text fields followed by a checkbox.

Each text field is used to write one hand configuration code, typically cutting and pasting from other files or the “Hand Configuration” window but also by directly reading a text file in which hand configuration codes have been saved. The role of the “File” menu items is related to this.

The first menu item (“Save bookmarks”, not visible in FIG. 5 in which the File menu is not expanded) of the File menu saves all the hand codes written in all the fields of the window “Bookmarks” to a text file chosen by browsing. The second menu item (“Load bookmarks,” also not visible in FIG. 5) reads hand codes written in a text file sequentially separated by blank spaces and loads them, one per text field, in the window “Bookmarks.”

The left button is used to create additional text fields with the corresponding checkbox.

The middle button executes whatever hand code has the corresponding box checked. If more than one box is checked the hand configurations are ‘added’ from top to bottom field. ‘Adding’ two configurations means that the second code is executed starting from the configuration of the first code (instead of starting from the neutral configuration).

This is particularly useful in correcting and/or refining hand configurations. The right button sets a keyframe for the hand in the configuration specified by the hand code with a box checked.

Typically, after refining the hand configurations created by hotkeys and recorded by the “Hand Configuration” window, the codes are written sequentially in the “Bookmarks” window and keyframed individually at chosen times to produce the desired animation. (see FIG. 6).

Refining the times of the keyframes is thus very quick and simple. Also, inserting additional keyframes requires only to keyframe an additional hand code. Erasing a keyframe is accomplished by keyframing a blank field (which creates the neutral hand configuration) or repeating the previous frame. This is not exactly removing the keyframe but in many practical cases it accomplishes the required results.

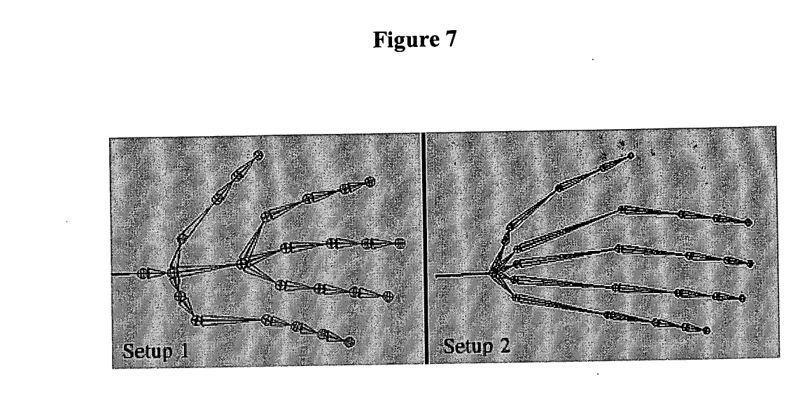

FIG. 7. The skeleton of the hand consists of 16 movable joints: 15 finger movable joints (three per finger) and the wrist joint. The 16 joints have a total of 26 dof. The wrist joint has 3 translation dof and 3 rotation dof; each of the 15 finger joints has one rotational dof (pitch); the lower joint of each finger has an additional rotational dof (yaw).

These 26 dof can be controlled independently. Generally rotational motions do not commute so interchanging the order of two rotations results in different configurations.

If this were the case, the keyboard input method would not be practically useful since the process of finding the correct configurations is done by successive approximations regardless of the order of the rotations. Fortunately it is possible to design a method for keeping the rotations independent of each other. This is based on using incremental Euler angles—a feature that is available in current versions of Maya and other commercial software.

The rotations of the finger joints and the translation and rotation of the wrist joint are quantized at the desired resolution. In our case the finger joints pitch motion is quantized in steps of 10 degrees; the finger joint yaw motion is quantized in steps of 5 degrees; the wrist rotations are quantized in steps of 20 degrees and the wrist translations in steps of 1 cm. These values are used as a practical example but it is clear that the values of the quantization steps can be tailored to the needs of the range of tasks required. It is useful to keep in mind that there is a proportionality between size of the quantization steps and speed of reconfiguring the hand. Accuracy is of course inversely related to step size.

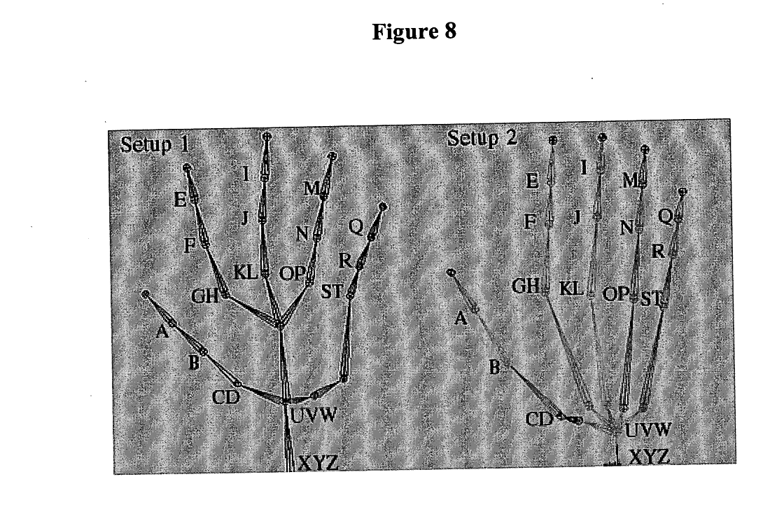

FIG. 8. In the process of reconfiguring the hand, we use alphabetical hot keys to move the hand into the desired configuration. The 26 letters of the alphabet correspond to the 26 dof of the hand. Capital letters are used for reversing the motions. As a hotkey is pressed, the corresponding dof is incremented or decremented (lower or upper case hotkey) in value by one quantization step. The hotkey letter is recorded by the program and appears in the upper text field of the “Hand Configuration” window for checking and monitoring one's keyboard actions.

Different human operators generally will reach the same configuration with different keystrokes. For example, starting from a reference configuration one operator may reach the ‘victory’ configuration (see FIG. 4) with the keystrokes: SsssssrrssrrmmRrrqqQqqqqToNNnnnooooonnnnnnpnnmmccmmcDDdbbaabaahL

Another operator may reach the same configuration with any permutation of the same keystrokes and/or with additional self-canceling sequences such as, e.g., CCcc.

As we can see from this example, the code, as recorded from the typed keystrokes, is not practical for storing, transmitting and/or combining with codes of other configurations.

The ‘compact code’ button changes the code to a compact form in which letters are sorted in alphabetical order, each letter being followed by a number indicating the number of repetitions of that letter keystroke. For the example above the compact code is:
a4b3c3DhLm4n9o6pq5r9s6T

This form of the code is much more legible and an operator can easily produce the corresponding hand configuration by typing in the alphanumeric keystrokes in the lower field of the same window and pressing the ‘execute code’ button. Again we remark that this is possible because the order of the rotations of the joint angles does not affect the final result.

The internal representation of the configuration code is a 26 component vector.

For the modeler/animator it is convenient to have an alphanumeric representation of the hand configuration as described above. For computational purposes, however, it is convenient to represent each value of the 26 dof as a signed integer. Positive values correspond to the lower case letters and negative values to the upper case letters.

Geometrically the integers are related to the joint rotations (and translation of the wrist) by the magnitude of the quantization steps chosen. For example, as we have mentioned, in our case all the finger joint pitch rotations have quantized rotations with 10 degree steps. The finger yaw rotations have steps of 5 degrees and the wrist rotation dof have steps of 20 degrees. The translations have steps of one unit of length. In the example above the alphanumeric code:
a4b3c3DhLm4n9o6pq5r9s6T
   is internally represented as the vector:
[4,3,3,−1,0,0,0,1,0,0,0,−1,4,9,6, 1,5,9,6,−1,0,0,0,0,0,0]

A variety of hand models can be freely downloaded from web sites or purchased from 3D graphics companies (i.e., www.viewpoint.com). Usually the model of the hand is a continuous polygonal mesh which can be imported into different 3D software packages.

Once the model has been imported, the creation of the skeletal deformation system is carried out by the animator in the 3D software of choice. There are currently 2 standard skeletal setups that are commonly used for hand animation: setup 1 involves the use of a 24-joint skeleton (see FIG. 7 on the left); setup 2 involves the use of a 26-joint skeleton (see FIG. 7 on the right).

Both setups include the 14 phalanges (14 movable joints) and the first and fifth metacarpal bones (2 joints). While setup 2 includes also the 2nd, 3rd, and 4th metacarpal bones (3 joints), setup 1 connects the 2nd, 3rd and 4th metacarpal bones into 1 joint.

Setup 2 uses a total of 5 bones (5 joints) for the thumb (2 carpal, 1st metacarpal, 1st proximal phalanx, 1st distal phalanx) and 5 bones (5 joints) for the pinky (1 carpal, 5th metacarpal, 5th proximal phalanx, 5th middle phalanx, 5th distal phalanx). Setup 1 makes use of 4 bones (4 joints) for the thumb (1 carpal, 1st metacarpal, 1st proximal phalanx, 1st distal phalanx) and 6 bones (6 joints) for the pinky (2 carpal, 5th metacarpal, 5th proximal phalanx, 5th middle phalanx, 5th distal phalanx).

The advantage of setup 1 lies in the presence of an extra 5th intermetacarpal joint which allows a more realistic motion of the pinky-cupping of the pinky. The advantage of setup 2 lies in the presence of all the metacarpal bones and the extra 1st intermetacarpal joint which allow an extremely realistic deformation of the top of the hand and the thumb.

Considered that in a real hand very little or no movement occurs at the intermetacarpal and carpal joints, we can think of these joints as non-movable and so eliminate the differences between the two skeletal setups. Even if the two setups present a different number of joints, because our method assigns a 0 dof to all the intermetacarpal and carpal joints, the total dof of both setups total 26 (see FIG. 8).

It is advisable to keep the non-movable joints as part of the skeletal setup even if they do not contribute to the motion of the hand. The function of these joints is primarily to facilitate the skinning process by creating a natural distribution of the skin weights thus allowing organic and realistic deformations during motion.

Given the above, our KUI method can be used to configure and animate any hand model that uses standard setups 1 or 2 as the skeletal deformation system (size, appearance and construction method—NURBS, Polygons, Subdivided Surfaces—of the hand are irrelevant).

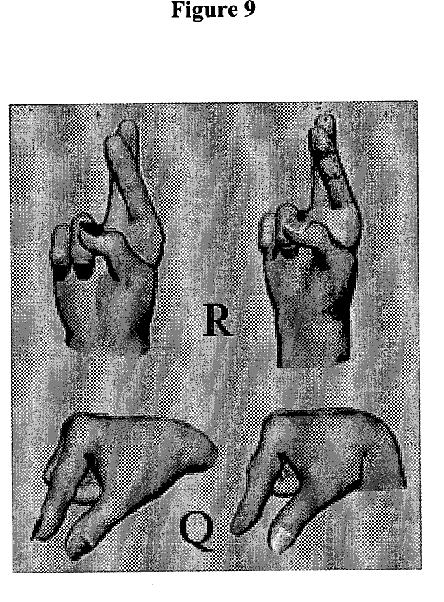

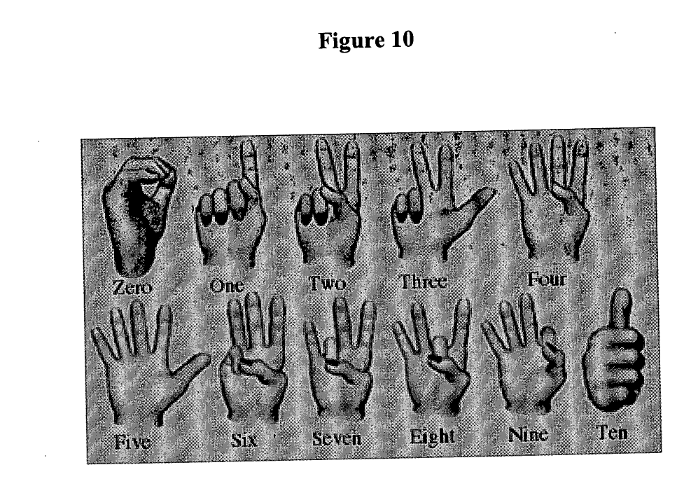

In general the accuracy of the hand configuration is inversely proportional to the magnitude of the quantization steps chosen. It is worth noting, however, that the visual effect can tolerate relatively large quantization steps. FIG. 9 shows, on the left, the Q and R manual alphabet hand shapes produced with our method (discreet rotation values) and, on the right, the same configurations produced with the selection and transformation tools of the 3D software (continuous rotation values). For this example all the finger joint pitch rotations have quantized rotations of 10 degree steps. The finger yaw rotations have steps of 5 degrees and the wrist rotation dof have steps of 20 degrees. With such rotation values we were able to achieve very accurate hand configurations (in FIG. 9 there is no noticeable difference between the configurations on the left and the ones on the right). FIG. 10 shows another example of ASL hand configurations (numbers 0 to 9) produced with the same quantized rotations. Table 2 contains the codes corresponding to each number configuration.

Such accuracy may not be surprising if we note, for example, that a quantization of the three wrist angles of 20 degrees results in 5832 possible orientations of the wrist and hence a significant visual discrimination requirement. We also note that this large quantization requires a maximum of only 9 key strokes for x, y and z to move to any desired orientation. (All this also assumes that the wrist is a spherical joint with no limits which in practice is not the case).

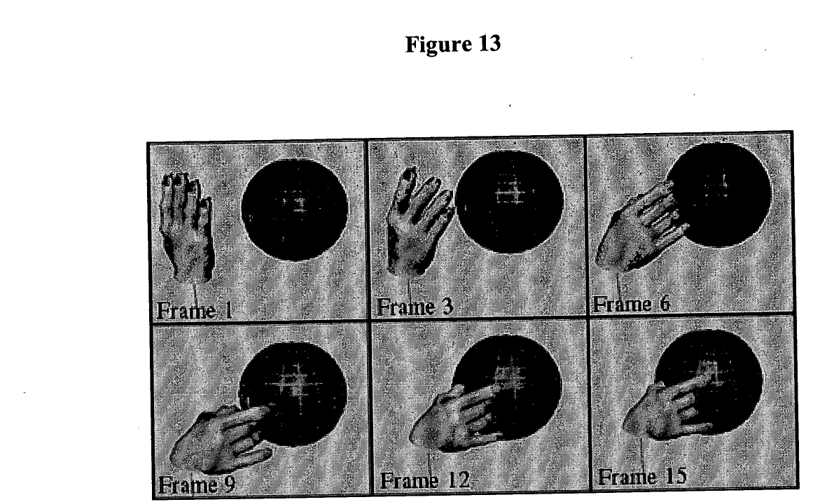

However, for hand configurations that require very careful positioning of the fingers to avoid obstacles and prevent collisions, such as fingers that need to fit in tight spaces (as in FIG. 13), the magnitude of the quantization steps can be easily reduced to accommodate the complexity of the hand shape. It is clear how the magnitude of the quantization steps is inversely proportional to the amount of time required to reach a particular configuration. While small quantization steps allow a high level of precision, a large number of keystrokes is required to reach the desired configuration.

TABLE 2
“Compact” codes corresponding to the ASL number
(0-10) configurations.

| Configuration | Code |
|---|---|
| Zero | ac2e2f4g3i4j5k2lm3n4o2p2q2r2s2t2U4 |
| One | a3b2c2D2i4j10k5m6n9o6pq6r8s6 |
| Two | a3b3c3DhLm6n9o6pq6r8s6T |
| Three | hLm6n9o6pq6r8s6T |
| Four | a3b4c2D2eT |
| Five | Ah2PT3 |
| Six | a3b5c3hq4r9s4t3 |
| Seven | a3b5c3h2m3n11o3p |
| Eight | a5b4c2dh2i4j10k4T2 |
| Nine | a5b2ce7f8g2PT3 |
| Ten* | A2D4e3f9g6Hi5j9k6m4n9o6pq5r9s6Tu4w3 |
| *(since the handshape is | A2D4e3f9g6Hi5j9k6m4n9o6pq5r9s6Tu6w3 |
| animated, it requires 3 | A2D4e3f9g6Hi5j9k6m4n9o6pq5r9s6Tu2w3 |
| codes, one for each | |
| position) | |

As explained below, the accuracy and smoothness of the animation is not only inversely proportional to the magnitude of the quantization steps chosen, but also directly proportional to the number of hand configurations (hand codes) used in the sequence.

In traditional keyframe animation, to animate a hand gesture, the animator selects the appropriate joints, transforms them to attain a particular hand pose and sets a keyframe (to set a keyframe means to save the transformation values of the joints at a particular point in time). After a keyframe has been set, the animator manipulates the joints to reach a different pose and sets another keyframe (at a different point in time). The process is repeated until the desired animation is accomplished. Once the keyframes for the sequence have been defined, the 3D software calculates the in-between frames and the animator decides which interpolation (linear, spline, flat tangents, stepped tangents etc.) the software should use to calculate the intermediate transformation values of the joints between the keyframes. All 3D programs allow the animator to edit the animation curves which are usually Bezier curves representing the relationship between time, expressed in frames (x axis), and transformation values (y axis). By editing the curves (scaling/rotating the tangents, adding or removing keyframes), the animator can tweak the animation with high level of precision.

With our method, the user enters a sequence of hand codes in the “Bookmarks” window and sets keyframes for each hand configuration. However, after recording the keyframes, the user does not have direct access to the curve tangents (set to flat). We could have included this as an option in the “Bookmarks” window but it would have defeated the object of the simplicity of the method. Being unable to access the animation curves might seem a severe limitation to the ability to refine the animation but actually the user can step through the animation and observe the hand. If the hand is not in the desired configuration at the observed frame, she can simply code in and keyframe that configuration.

The method involves the following steps: (1) in the lower field of the “Hand Configuration” window the user enters the code of the keyframe closest and preceding the frame to change; (2) after returning the hand to neutral position, she presses ‘execute code’; (3) the user clears the input (upper) field of the “Hand Configuration” window; (4) using the hotkeys she brings the hand in the desired configuration; (5) she presses “compact code”—this will produce (in the lower field) the code for the desired configuration—; (6) she uses this code in the “Bookmarks” window to set an additional keyframe.

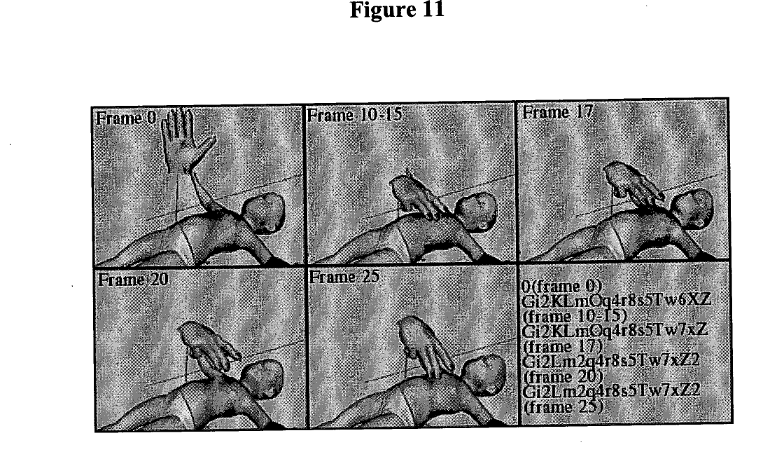

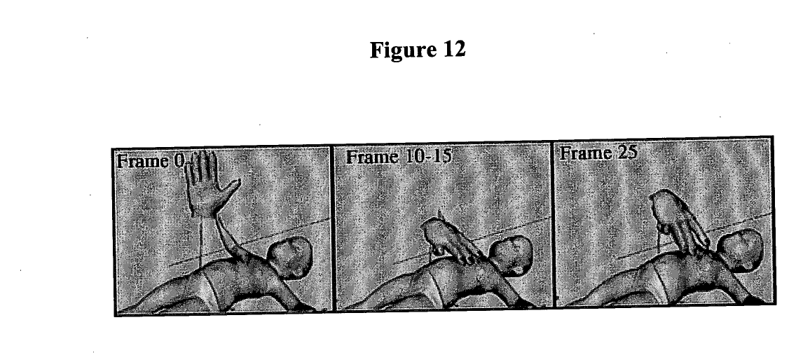

By keyframing additional hand codes, the user can refine the animation with high level of precision. FIG. 11 shows the 5 code-based keyframes used to produce the animation illustrating the right hand configuration and motion in infant CPR (chest compression phase). FIG. 12 shows the 3 standard keyframes used to produce the same sequence.

In order to achieve the level of smoothness and precision as in the sequence in FIG. 12 and avoid the intersection of the middle finger with the infant's chest, we were required to add 2 extra keyframes (frames 17 and 20, FIG. 11). The two additional hand codes cause the y translation of the wrist joint to occur before the pitch rotation hence avoiding the intersection of finger and body. The same problem could not have been solved by simply decreasing the magnitude of the quantized rotations and translations of the wrist joint. In sequence 2 (FIG. 12) no additional keyframes were required since the intersection was prevented by editing the curve tangents of the wrist joint rotation and translation.

The sequence in FIG. 13 is another example of how the animation can be refined and precisely controlled by adding keyframes and/or adjusting the resolution of the quantization steps. FIG. 13 illustrates a case of configuration and animation in low clearance and occluded areas. Such areas present several challenges since they require precise positioning to avoid obstacles and careful animation to prevent collisions. In order to fit the fingers in such tight spaces and avoid intersection with the bowling ball 3 additional keyframes (frames 3, 6 and 12, FIG. 13) were used and the quantized rotations for the wrist joint were decreased to 10 degree steps.

Poses, as we have seen, are represented as 26 dimensional vectors of integers. We use the term vector in the mathematical sense, not as defined in MEL (Maya Embedded Language) where ‘vector’ is a term reserved for mathematical 3 dimensional vector. The MEL language would describe what we call a 26 dimensional vector as an ‘array of size 26’.

Since a pose is a set of 26 integers it is straightforward to store it. For convenience, the window “Bookmarks” contains the menu “File” with two menu items: “Save bookmarks” and “Load bookmarks” which, as described above, allow storage and retrieval of poses from simple text files. Transmission of poses is then reduced to transmitting sets of 26 integers (for example in text files but also directly). A comparison can be made with exporting and importing clips of poses. This process requires typically at least twenty times more memory.

For animations, our method allows the encoding of animations as keyframes described as pairs composed of an integer for the time and the 26 dimensional vector describing the pose at that time. Thus sets of 27 integers form the description of an animation. However this process is not, at the moment, independent of the Maya interface since it relies on the tweaking done by Maya between keyframes. The method can be extended and generalized to be applicable across different animation packages.

### EXAMPLE 1

We introduce a new method which utilizes the user's typing skills to control, with high level of precision, the motion of the fingers (fingers flexion, abduction and thumb crossover), arching of the palm, wrist flexion, roll and abduction of a computer generated three dimensional realistic hand.

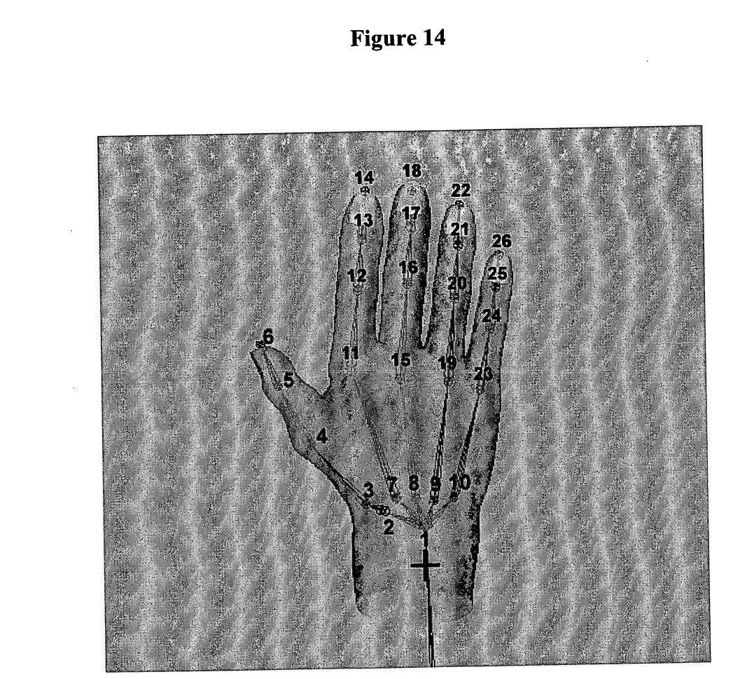

The hand has 26 degrees of freedom which can be controlled by the 26 letters of the alphabet. FIG. 14 shows the skeletal structure of the hand with its 26 joints and the IK end-effect or (represented by the cross) that controls the positioning of the hand in the 3D environment.

Via keyboard input the hand can be positioned in space and manipulated to attain any pose: by touching a letter key the user rotates the corresponding joint a pre-specified number of degrees around a particular axis. The rotation “quantum” induced by each key touch can be easily changed to increase or decrease precision. For specific applications (e.g. fist or single digit action) the number of movable joints can be conveniently reduced.

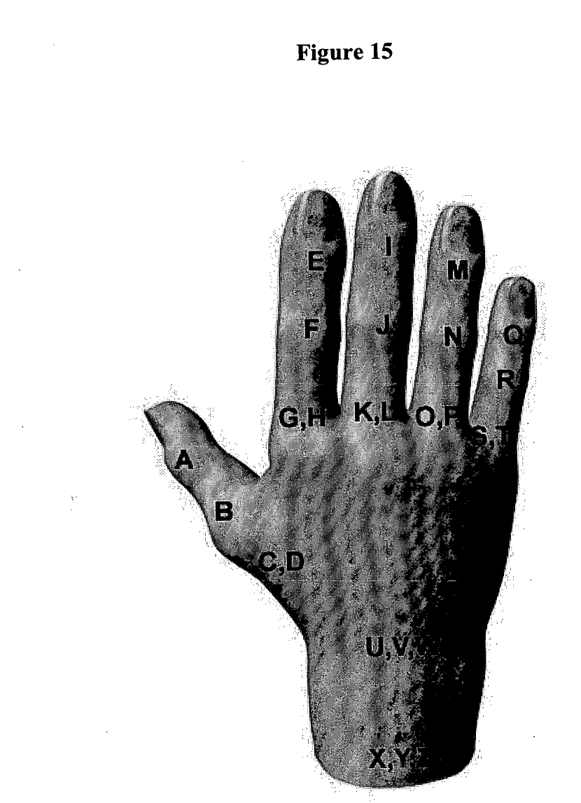

The hand that we present was modeled as a continuous polygonal mesh and makes use of a skeletal deformation system animated with both Forward and Inverse Kinematics. The structure of the CG skeleton closely resembles the skeletal structure of a real hand allowing extremely realistic gestures. Using MEL (Maya Encrypted Language) we have created a program that encodes hand gestures by mapping each letter key of the keyboard to a degree of freedom of the hand (Lower case letters induce positive rotations of the joints, upper case letters induce negative rotations of the joints). FIG. 15 shows a rendering of the hand with the joints' rotations (23) and IK effect or translation parameters (3) mapped to the 26 letters of the alphabet. Table 3 shows the motion output produced by each letter key.

TABLE 3

| Letter Key | Motion output |
|---|---|
| A | Rotation of 1^{st} Distal |
| | Phalanx bone (Thumb |
| | flexion-z rot of joint 5) |
| B | Rotation of 1^{st} Proximal |
| | Phalanx bone (Thumb |
| | flexion-z rot of joint 4) |
| C | Rotation of 1^{st} Metacarpal |
| | bone (Thumb abduction-y |
| | rotation of joint 3) |
| D | Rotation of 1^{st} Metacarpal |
| | bone (Thumb crossover-z |
| | rotation of joint 3) |
| E | Rotation of 2^{nd} Distal |
| | phalanx bone (Index |
| | flexion-z rotation of joint |
| | 13) |
| F | Rotation of 2^{nd} Middle |
| | Phalanx bone (Index |
| | flexion-z rotation of joint |
| | 12) |
| G | Rotation of 2nd Proximal |
| | Phalanx bone (Index |
| | flexion-z rotation of joint |
| | 11) |
| H | Rotation of 2nd Proximal |
| | Phalanx bone (Index |
| | flexion-y rotation of joint |
| | 11) |
| I | Rotation of 3rd Distal |
| | phalanx bone (Middle |
| | finger flexion-z rotation of |
| | joint 17) |
| J | Rotation of 3rd Middle |
| | Phalanx bone (Middle |
| | finger flexion-z rotation of |
| | joint 16) |
| K | Rotation of 3rd Proximal |
| | Phalanx bone (Middle |
| | finger flexion-z rotation of |
| | joint 15) |
| L | Rotation of 3rd Proximal |
| | Phalanx bone (Middle |
| | finger abduction-y |
| | rotation of joint 15) |
| M | Rotation of 4th Distal |
| | phalanx bone (Ring finger |
| | flexion-z rotation of joint |
| | 21) |
| N | Rotation of 4th Middle Phalanx |
| | bone (Ring finger flexion-z |
| | rotation of joint 20) |
| O | Rotation of 4th Proximal Phalanx |
| | bone (Ring finger flexion-z |
| | rotation of joint 19) |
| P | Rotation of 4th Proximal Phalanx |
| | bone (Ring finger abduction-y |
| | rotation of joint 19) |
| Q | Rotation of 5^{th} Distal phalanx |
| | bone (Pinkie flexion-z rotation of |
| | joint 25) |
| R | Rotation of 5th Middle Phalanx |
| | bone (Pinkie flexion-z rotation of |
| | joint 24) |
| S | Rotation of 5th Proximal Phalanx |
| | bone (Pinkie flexion-z rotation of |
| | joint 23) |
| T | Rotation of 5th Proximal Phalanx |
| | bone (Pinkie abduction-y rotation |
| | of joint 23) |
| U | Wrist roll (x rotation of joint 1) |
| V | Wrist abduction (y rotation of |
| | joint 1) |
| W | Wrist flexion (z rotation of joint |
| | 1) |
| X | X translation of the hand |
| Y | Y translation of the hand |
| Z | Z translation of the hand |

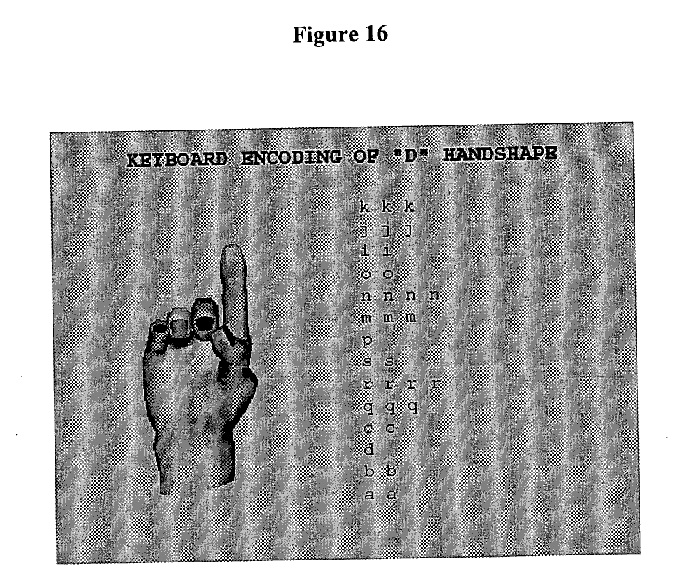

FIG. 16 shows an example of keyboard encoding of the “D” handshape of the American Sign Language (ASL) alphabet. Lower (upper) case letter keys induce a positive (negative) 10 degrees joint rotation.

The design of this touch-typing reconfigurable hand can be easily extended to other models. In particular, the design is equally suitable for lower polygonal representation of the modeled hand so that operation outside the Maya environment is possible. In particular we have exported a simplified hand model from Maya to Macromedia Director 8.5. From such platform the touch-typing hand reconfiguring can be performed on web deliverable interactive application programs. Finally, the design of the touch-typing reconfigurable hand lends itself to easy memorization of the joint-letter relations so that a moderately skilled touch typist can easily acquire dexterity in configuring the modeled hand. Letters can be maintained on the model during the initial phase of acquiring the skill.

### EXAMPLE 2

So far the KUI method has been applied to hand reconfiguration tasks. Beyond such basic tasks, many motor skills require the representation of basic actions such as: grasp, release, push, pull, hit, throw, catch, etc. In this work we focus on grasp and release two of the most common and useful actions in any purposeful hand motion. This embodiment extends the KUI method to include these two operations.

Grasp classification is still a matter of research. There have been several stages and directions of development of a grasp taxonomy in the last twenty years. The main approaches to grasp taxonomy can be reduced to three types: (1) Taxonomies based on task to be accomplished by grasping; (2) Taxonomies based on shape of object to be grasped; (3) Taxonomies based on type of hand-contact in grasping.

In the first type the main factors considered are: (a) power and intensity of the grasp task, (b) trajectory in the grasp task, and (c) configurations in specific grasp tasks. Power and intensity were the criteria used to distinguish between power grasps, required in tasks when strength is needed, and precision grasps, required when it is necessary to have fine control. Trajectory was considered to distinguish grasp in the up, down, right, left, directions as well as grasps in circular, sinusoidal and other motions. Specific grasp tasks were considered in manufacturing and as the basis of occupational therapy oriented tasks. Recently a subset of the 14 Kamakura (See Kamakura, N. Te no ugoki. (1989). “Te no ugoki. Te no katachi” (Japanese). Ishiyaku Publishers, Inc. Tokyo, Japan) grasps has been used in robotics applications.

Taxonomies based on shape of object to be grasped have been considered, e.g., by animators, to simplify the description and production of hand animation. The objects considered were: thin cylinder, fat cylinder, small sphere, large sphere and a block.

Taxonomies based on type of hand-contact in grasping were considered within the context of opposing forces by. A compromise between flexibility and stability is reached by the pad opposition between the pad of the thumb, fingers, palm, and side. More recently Kang and Ikeuchi have introduced the concept of contact web which is a 3D graphical representation of the effective contact between the hand and the held object (See Kang, S. B., Ikeuchi, K. (1993). “A grasp abstraction hierarchy for recognition of grasping tasks from observations”, IEEE/RSJ Int'l Conf on Intelligent Robots and Systems, Yokohama, Japan). The grasp taxonomy developed on the basis of the contact web distinguishes volar and non-volar grasps, the former being grasp involving palmar interaction. The non-volar grasp is further subdivided into fingertip grasps (if only the fingertips are involved in the grasp) or composite non-volar grasp (if both fingertips and other finger segments are involved).

Our classification takes into account the three main classification types described above but it is based primarily on shape of the object and type of hand contact. This choice is motivated by the kind of application considered, i.e., 3D animation.

Although task oriented classifications are useful in many applications we think that in our case (animation) the grasping task must be kept as general as possible and hence the specific task cannot be the determining criterion in specifying the grasp description.

On the other hand, since our grasp description is mainly for animation but has applications to robotic in imitation learning, we have taken into account the robotic task description in reducing the grasp types considered.

Thus our taxonomy must be compared mostly with the classifications for animation and robotics. We should also keep in mind that our classification does not need to be complete since it is adjustable after pre-grasping is performed. In fact our classification should be considered primarily a pre-grasp taxonomy.

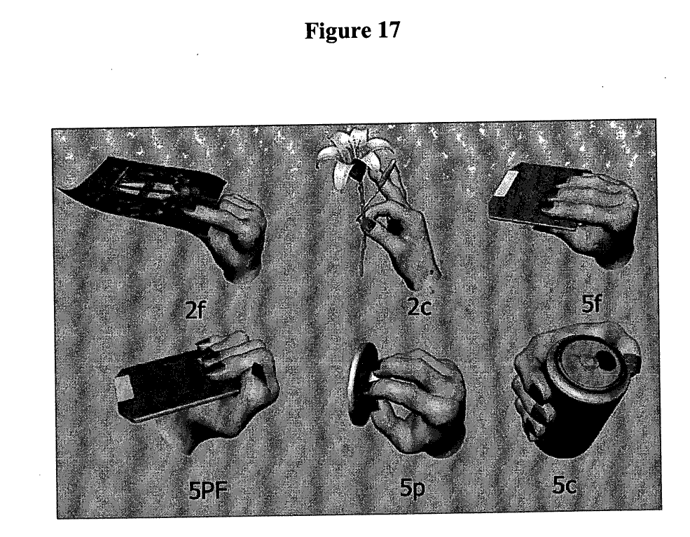

Our classification reduces the basic pre-grasp configurations to six (FIG. 17). For each pre-grasp configuration we can select intermediate configurations between a fully open and a fully closed grasp configuration. As described below in the section on the interface, the program is set for automatic selection of any of 5 intermediate configurations. This is generally sufficient but can easily be extended to a finer degree of intermediate configurations.

Our pre-grasp taxonomy adopts the following symbol notation. The number refers to the number of fingers involved. The lower case letters denote grasp adjectives as follows: f=flat; c=c-shaped; p=pointed. The upper case letters denote grasp nouns as follows: P=palm; F=finger. The six pre-grasps considered are illustrated in FIG. 1 where the corresponding notation is indicated. We consider only grasp of rigid solid objects; so we can only change position and orientation of the object. We do not change the shape of the object which is assumed to be a rigid solid.

The HCI introduced above has been modified and extended and now includes three windows: (1) the “Hand Configuration” window, (2) the “Animation” window, and (3) the “Pose Library” window.

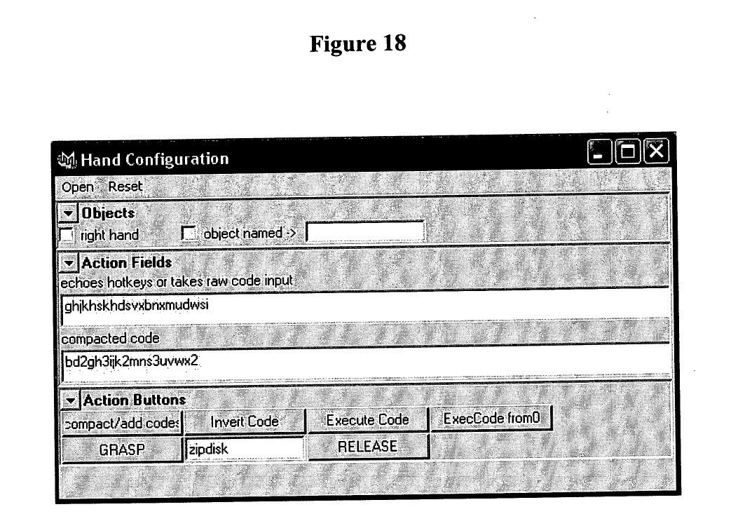

The “Hand Configuration” window (FIG. 18) has three collapsible frame layouts: (1) the “Objects” frame; (2) the “Action Fields” frame; and (3) the “Action Buttons” frame.

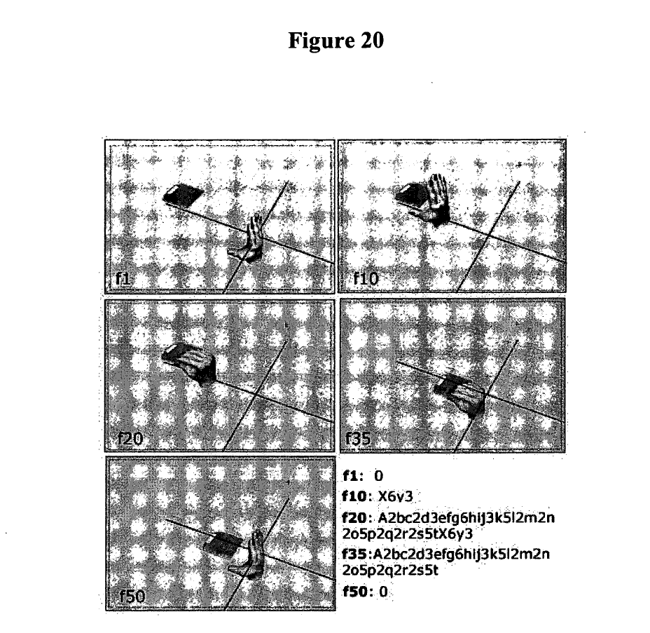

The two menus above the three frames are used to open the other two windows and to return the hand in its neutral position (the neutral position of the hand is shown in FIG. 20 in the top left frame). The upper frame is used to select the objects on which KUI actions are performed. KUI input can be applied to the hand or to objects to be manipulated. In the latter case only translation and rotation of solid objects is relevant thus only the keys uvwxyz (which control, respectively, translation xyz and rotation xyz) can be applied; the other keys refer by default to the rotation of the hand joints.

The middle frame consists of two fields: the upper field echoes the hotkeys used to configure the hand (it can also be used to type in code in any form, raw or compacted, sorted or not); the lower field contains compacted code, i.e., a compact form in which letters are sorted in alphabetical order, each letter being followed by a number indicating the number of repetitions of that letter keystroke.

The third frame contains six buttons and one text field. The upper-row buttons perform the following actions (from left to right): (1) The first button compacts the code from the upper field and writes it in the lower field. If code is present in the upper and lower fields the two are added together. This operation is useful when planning animation steps; (2) the second button inverts the code written in the lower field. This is useful to retrace steps in planning animation; (3) the third button executes the compacted code in the lower field (the hand or the object selected in the “Objects” frame will reconfigure itself accordingly and the reconfiguration is relative to the current position/orientation); (4) the fourth button operates as the third button but executes the code from the neutral position at the origin and applies only to the hand. The lower row buttons perform grasp and release actions on the object written in the text field.

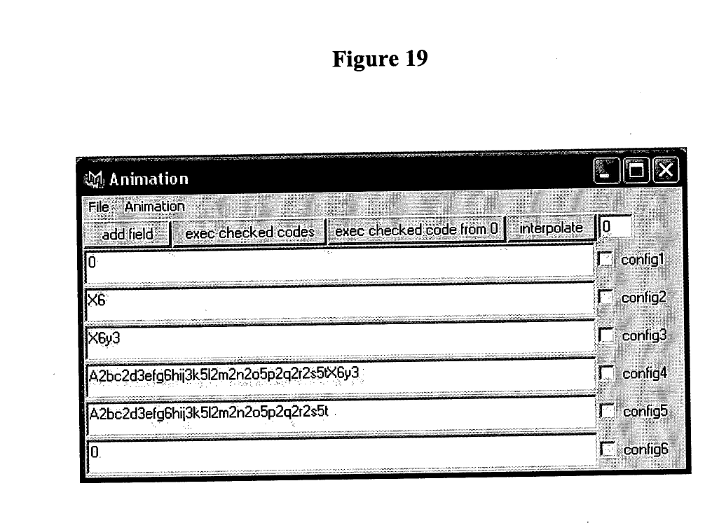

The “Animation” window (represented in FIG. 19) is opened by the “Animation” submenu of the “Hand Configuration” window, menu “Open.” The window “Animation” consists of “File” and “Animation” menus, four buttons and an arbitrary number of text fields followed by a checkbox.

Each text field is used to write one hand configuration code, typically cutting and pasting from other files or the “Hand Configuration” window but also by directly reading a text file in which hand configuration codes have been saved. The role of the “File” menu items is related to this.

The first “File” menu item (“Save bookmarks,” not visible in FIG. 19 in which the File menu is not expanded) of the File menu saves all the hand codes written in all the fields of the window “Animation” to a text file chosen by browsing. The second menu item (“Load bookmarks,” also not visible in FIG. 19) reads hand codes written in a text file sequentially separated by blank spaces and loads them, one per text field, in the window “Animation.”

From left to right, the first button is used to create additional text fields with the corresponding checkbox. The second button executes whatever hand code has the corresponding box checked. If more than one box is checked the hand configurations are ‘added’ from top to bottom field. ‘Adding’ two configurations means that the second code is executed starting from the configuration of the first code (instead of starting from the neutral configuration). This is particularly useful in correcting and/or refining hand configurations. The third button operates as the second but executes the codes from the neutral hand position at the origin. The fourth button generates interpolated codes from two codes written in the first and last field. The total number of codes, including the original ones, is specified in the upper right box. Obtaining interpolated codes is particularly useful in smoothing animation and provides a KUI alternative to the automatic in-betweening of the software used. It is of practical use also for refining configurations provided by a library. Typically, after refining the hand configurations created by hotkeys and recorded by the “Hand Configuration” window, the codes are written sequentially in the “Animation” window and keyframed individually at chosen times to produce the desired animation. (FIG. 20).

For the “Animation” menu, the first submenu (set keyframe) sets a keyframe for the hand in the configuration specified by the hand code with a box checked. The keyframes and all the animation is cleared by the last submenu (clear hand animation). Erasing a single keyframe can be accomplished by keyframing a blank field (which creates the neutral hand configuration) or repeating the previous frame. The other submenus refer to grasp animation. The ‘start grasp’ and ‘end grasp’ submenus have the same function as the GRASP and RELEASE buttons in the Hand configuration window. They can also be implemented by the hot keys “+” and “−”. The “return grasped” submenu repositions the grasped object to its original location before the animation started.

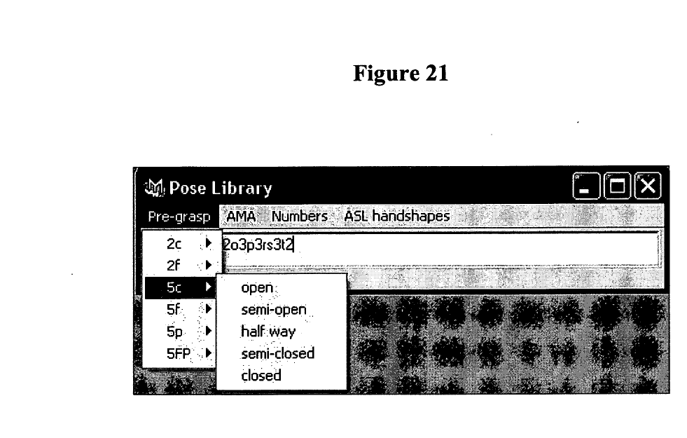

The “Pose Library” window (FIG. 21) is opened by the “Pose Library” submenu of the “Hand Configuration” window, menu “Open.” The window “Pose Library” consists of four menus and a field.

The first menu contains a library of poses for the hand in pre-grasping configurations corresponding to the grasp classification presented in the previous section. Various intermediate configurations from open hand to closed hand are given.

The second menu contains the standard letters of the American Manual Alphabet which is used in sign language. The numbers are given in the third menu and additional hand configurations used in American Sign Language (ASL) are given in the fourth menu. With this pose library practically any hand configuration can be approximated to the point that further refinement requires little effort and time.

FIG. 6 shows an example of an application of the method to teaching grasping of dental instrumentation for Mandibular Anteriors.

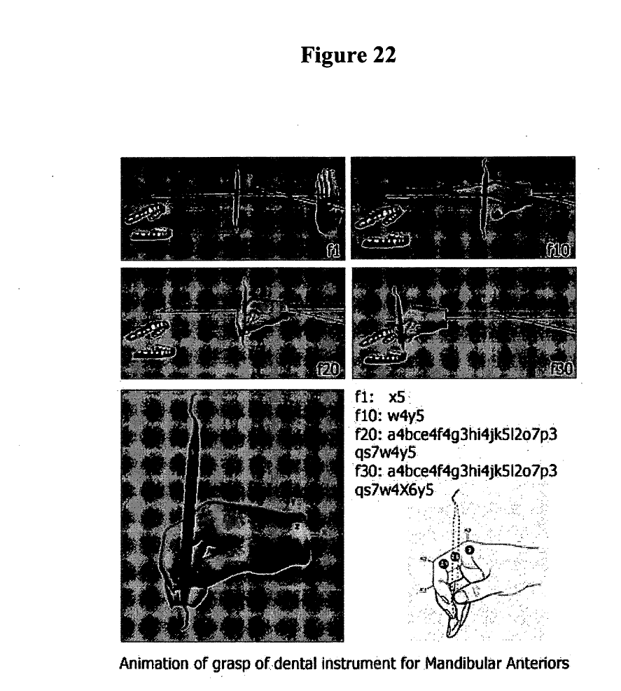

To reach the final grasp configuration we have used the 5c semi-closed pre-grasp type and we have refined the configuration of the fingers and hand orientation using KUI. Very few keystrokes were necessary to attain the correct hand pose. The animation data of the grasp action is represented by the four text codes (one per keyframe) shown in the bottom right section of FIG. 22.

This should be regarded as an example of the extension of the capabilities of the recently presented KUI method to include the tasks of grasping and releasing. We have designed a new grasp classification scheme based on shape of the object and type of hand contact. The new grasp taxonomy, which reduces the grasp types to six, is particularly useful for animation applications in fields of science and technology and also music and crafts. The KUI interface introduced has been extended to record animation of grasp and release actions.

The keyboard based method of grasp and release is particularly suitable to teaching manual skills (e.g., in dentistry, surgery, mechanics, musical instrument playing, and sport device handling) at distance (via web). The advantages presented by the method are: (1) ease of use (any instructor or student with no animation skills can quickly model a large number of grasp configurations, touch-typing being the only skill required); (2) high speed of input; (3) low memory storage; and (4) low bandwidth for transmission, especially for web delivery.

### EXAMPLE 3

Particularly useful with this method, is a reconfigurable keyboard. Although described below in relation to hand gestures, applicability may be extended to facial expressions, head motion/orientation and other complex articulations.

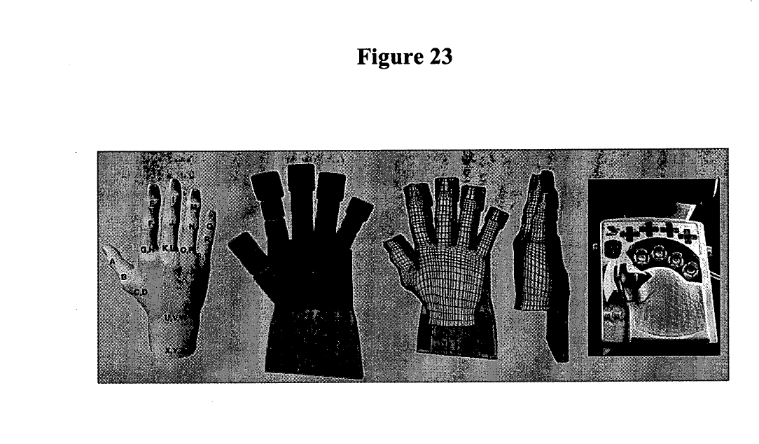

In this embodiment of the invention, a hand shaped keyboard layout is developed, which is of simple realization and is reconfigurable into layout suitable for different joint structures to be controlled (e.g., facial expressions and full-body postures). There are many types of keyboards commercially available and designed for a variety of special needs. The technology is highly developed and a reconfigurable keyboard requires overlaying a new label layout and reprogramming the keyboard appropriately. The reprogramming can be done from a utility program in which the user composes a soft keyboard graphically according to the required task (e.g. hand manipulation, facial expressions, leg/arm posture etc.). This reconfigurable keyboard is the first step toward the development of a new hand shaped anatomical keyboard for accurate and easy modeling/input of hand gestures. FIG. 23 shows the mapping of the hand joints to the letter keys (on the left); a preliminary concept model of hand shaped keyboard, (in the center); and the commercially available DATAHAND™ keyboard, (on the right).

The hand shaped keyboard would have an “anatomical cradle” to support the hand, similar to the DATAHAND™ keyboard. The fundamental difference between our hand shaped keyboard and the ergonomic keyboards currently available on the market (i.e., DataHand, Kinesis, Pace, Maltron two-handed keyboard, Touchstream, etc.) lies in the location of the keys. All keyboards produced so far have a key layout designed for text input. Nobody has optimized the location of the keys so that the layout of the key sites corresponds to the layout of the movable joints of the object to be configured. Such optimized layout would allow intuitive and natural input of hand gestures since the motion of the operator's fingers would mimic, e.g., the motion of a hand guiding another hand placed under it.

Another difference between the hand shaped keyboard and commercially available keyboards or game controllers lies in the input movements. The hand shaped keyboard does not include mouse-type (continuous) motions since the KUI method has input and output discretized, as keystrokes and rotations of the joints respectively. This results in more simplicity and less costly construction. Continuous values can also be input by keyboard if suitably programmed (see 0015 above) but for clarity we now focus on discrete steps input.

While several alternative methods are being investigated for input of hand gestures, these techniques are generally relying on complex and expensive hardware (e.g., motion capture cybergloves and vision based recognition systems). For many applications, such as robotic assisted manipulation of ordinary objects by elderly and/or disabled individuals, a simpler and less expensive technique is highly desirable.

For instance, in robot-assisted care to the elderly and/or invalid it is necessary to guide a robotic hand to perform manipulative tasks such as reaching, grasping and delivering objects to the patient. The latter has limited ability to control the robotic hand. One option is via voice input but often the patient has also limited speech capabilities and in any case, even for speech unimpaired patients, there is no currently available efficient method of guiding the precise motions of hands by verbal commands.

The simplest (from an HCI point of view) way of controlling the precise motion of a robotic manipulator is via a hand-held controller with input keys corresponding to the degrees of freedom of the manipulator. But such a controller is suitable for a limited number of dof and for technical operators (typically teaching the robot new positions) rather than for ‘natural’ operation by a non technical and partially disabled operator. A standard keyboard input is also too demanding for such an operator. What is desirable is a ‘natural’ way of inputting commands so as to move precisely a robotic hand.

We believe that the KUI technique, optimized by the development of a hand shaped anatomical keyboard, provides a hand gesture input/modeling method which requires no (or minimal) learning and minimal effort of operation. Such method would be extremely valuable in other fields such as: HCI for gaming involving hand gestures; signed communication, e.g., American Sign Language (ASL); character animation; visual recognition gestures; training in professions that require high level of dexterity (e.g., surgery, mechanics, dentistry, defusing of explosive devices, etc.).

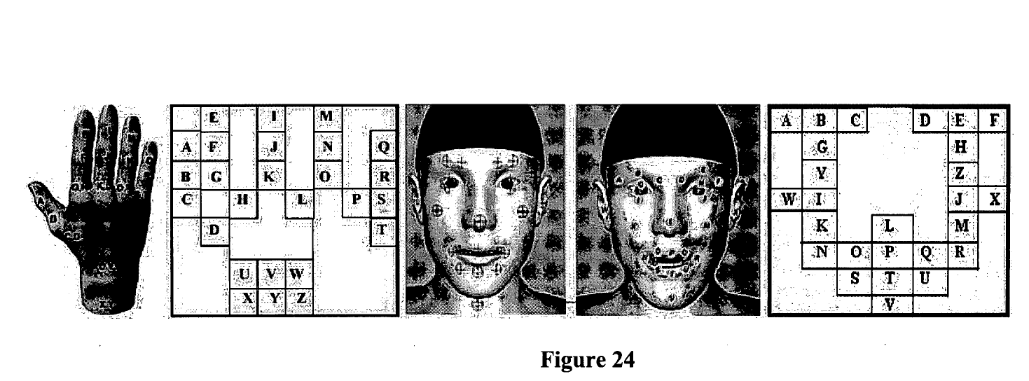

The development of a hand shaped keyboard layout which is reconfigurable into layout suitable for different joint structures has been shown to be feasible. The specialized keyboard consists of an 8×8 matrix of key sites which can be occupied by alphabetically labeled keys in any order. (using, e.g., the KB3000 programmable membrane keypad.) An example of key layout for the case of hand gesture input is given in FIG. 24 on the left.

The position of the keys correspond to the projection of the hand joints on the keyboard plane. FIG. 24, on the right, shows another example of the same keyboard with layout configured for input of facial expressions.

We have developed a benchmarking process by which we can measure and compare the average speed of hand gesture input by using: (a) the KUI method optimized by the specialized keyboard layout, (b) the KUI method with the standard keyboard; (c) the 18-sensor cybergloves.

The benchmarking process applied to (a) and (b) provides a quantitative measure of the efficiency of using a customized keyboard layout versus a standard one. The results determined the performance advantages of the prototype customized keyboard and were used to design an improved second version of the latter.

When comparing speed of input of (a) and (c), it is found that hand gestures input via cybergloves require a shorter time than input via KUI method. However, the speed of input is function of the number of hand gestures to be configured. For example, when a low number of hand configurations needs to be input, the speed comparison might be in favor of the KUI method since the latter does not require any initial setup time (i.e., putting on the gloves and calibrating them to fit the geometrical parameters of the user's hand). The benchmarking process provides a quantitative measure of the cutoff number of hand poses for which the cybergloves are worthwhile.

### EXAMPLE 4

Currently facial surfaces are controlled and manipulated using one of three basic techniques: (1) 3D surface interpolation; (2) ad hoc surface parameterization; (3) physically based techniques with pseudo-muscles.

In terms of human computer interaction (HCI), the emphasis of facial expression research has been on computer vision techniques for facial configuration input and processing, and categorization of facial expressions relevant to enhancing communication between man and machine.

In this example we demonstrate that the human face, which consists of 44 bilaterally symmetrical muscles (muscles of facial expression and muscles of mastication), can be modeled with muscle (or group of muscles) actions totaling 22 degrees of freedom+4 degrees of freedom required to control the direction of the gaze. Thus, it is possible to create a facial model confined to a parameter space not excessively large in terms, not only of computer representation, but also of human encoding. It is this characteristic that has suggested the approach to facial expression encoding described below.

A convenient facial configuration encoding is applicable to many practical tasks: (1) teaching the facial components (non-manual markers) of American Sign Language. The 26 facial parameter set could be easily optimized for keyboard encoding of facial expressions specific to the grammar of ASL; (2) Human Computer Interface, i.e., the possibility of building computer interfaces which understand and respond to the complexity of the information conveyed by the human face. Currently, information has been conveyed from the computer to the user mainly textually or visually via ad hoc images; (3) Testing and quantitative calibration of vision algorithms for the analysis and recognition of video data involving faces; (4) Communication with patients suffering from textually impaired syndromes, e.g., severe dyslexia; (5) Development of socially adept interfaces for the communication of social displays in the acknowledgement of actions by other people, e.g., by smiling in response to intention to purchase a certain item; (6) web deliverable 3D character animation. A simple set of (26) component vectors can represent a facial configuration and could be transmitted with very low bandwidth to animate complex face models held at the receiver site.

The human face is a complex structure of muscles whose movements pull the skin, temporarily distorting the shape of the eyes, brows, and lips, and the appearance of folds, furrows and bulges in different areas of the skin. Such muscle movements result in the production of rapid facial signals (facial expressions) which convey four types of messages: (1) emotions; (2) emblems—symbolic communicators, culture-specific (e.g., the wink); (3) manipulators—manipulative associated movements (e.g., lip-biting); (4) illustrators—movements that accompany and emphasize speech (e.g., a raised brow).

Given the complexity of the human face, the first challenge faced by this embodiment has been the determination of a relatively small set of facial parameters (26) able to encode any significant facial expression of a 3 dimensional computer generated face. There are several approaches to developing facial parameters including observation of the surface properties of the face and study of the underlying structure, or facial anatomy. However, which parameters are best included in a simple model of facial expression remains unresolved. Below we describe our proposed new set of parameters.

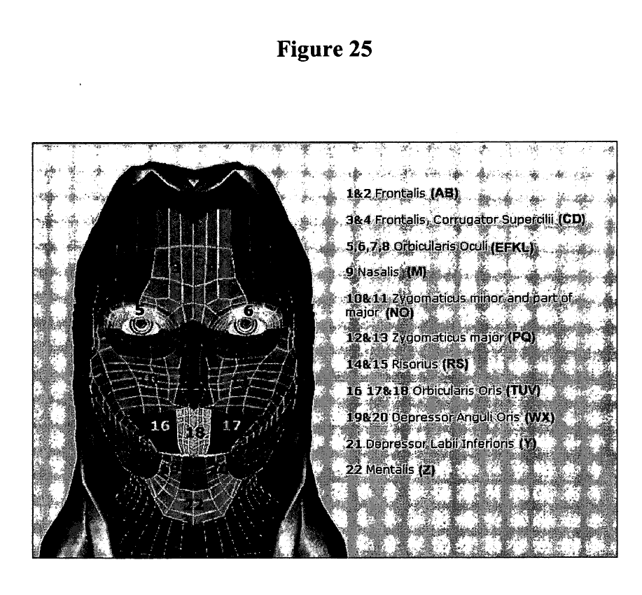

The eyes and mouth are of primary importance in facial expressions thus many of our facial parameters relate to these areas. We have modeled a 3 dimensional face as a continuous polygonal mesh and we have identified 22 regions on the mesh. The definition of the regions is based on the anatomy of the face and in particular on the location of the muscles of Facial Expression. FIG. 25 shows the 22 regions identified on the 3D face model. Each region of mesh is controlled by one joint. The translation of the joint produces a proportional (quasi linear) deformation of the corresponding skin region. The type of deformation has been determined based on the observation of the change of facial shape produced by the action of the muscle or set of muscles located in that region. The Facial Action Coding System (FACS) has provided us with a complete list of possible muscle contractions or relaxations performable on a human face with relative induced deformations. FACS lists all the basic actions (called Action Units or AUs) that can occur on the human face (e.g., Inner Brow Raiser, Lip Tightener, Chin Raiser) and describes a facial expression as a combination of specific AUs. In the next section we demonstrate that it is possible to encode, via keyboard input, 94% of the FACS Action Units (we have not considered those relative to head orientation) with our 26 (22+4) parameter set.

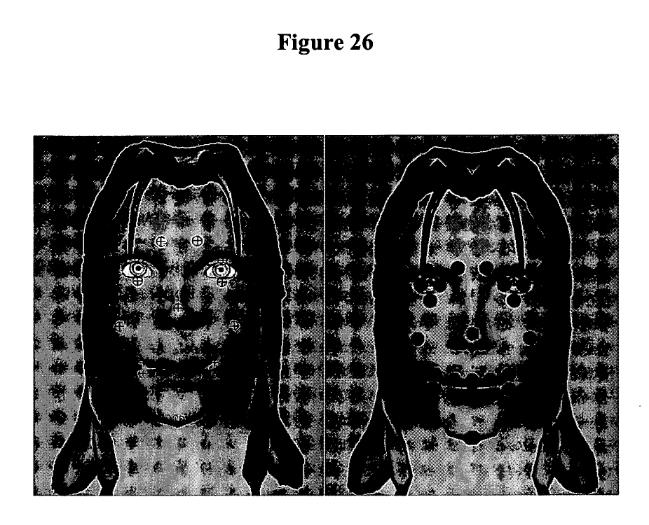

Using MEL (Maya Encrypted Language) we have created a program that encodes the facial expression of the above described three dimensional face by mapping each letter key of the keyboard to a degree of freedom of the face (lower case letters induce positive translations of the joints and positive rotations of the eyes, upper case letters induce negative translations of the joints and negative rotations of the eyes). FIG. 26 shows the locations of the 22 facial joints, on the left, and a rendered image of the face with the joints' transformation (22) and eye rotation parameters (4) mapped to the 26 letters of the alphabet, on the right. Table 4 shows the deformation output produced by each letter key. We note that letter ‘z’ controls the deformation induced by the mental is muscle as well as the rotation of the jaw.

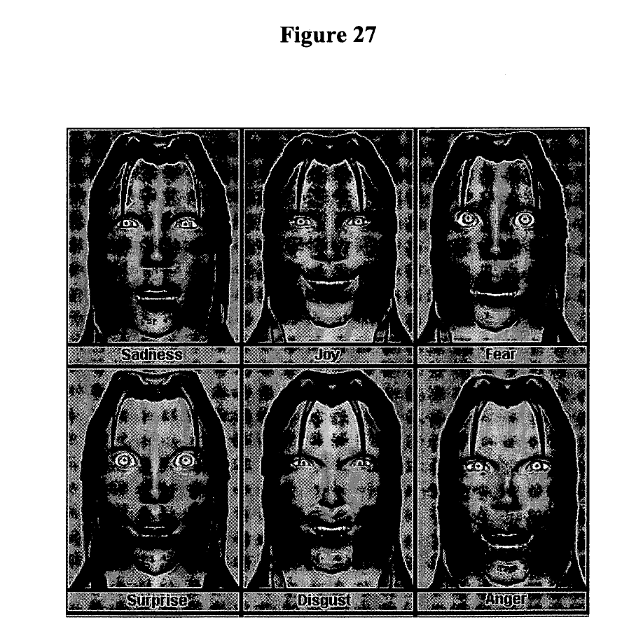

Via keyboard input the face can be configured to attain any expression: by touching a letter key the user translates the corresponding joint a pre-specified number of units along an axis. The letters “G H I J” control the rotation of the eyes and therefore the direction of the gaze. The eyes have been modeled as two separate spheres with procedural mapped pupils. The rotation of each sphere around the Y axis causes the eye to look left or right; the rotation of each sphere around the X axis causes the eye to look up or down. The transformation “step” induced by each key touch can be changed to increase or decrease precision. FIG. 27 shows an example of keyboard encoding of the six basic facial expressions commonly used in animation (anger, joy, surprise, fear, disgust, sadness), table 5 shows the letter codes corresponding to each expression.

[image]

TABLE 5
Keyboard encoding of the six basic facial expressions.

| Emotion | Letter Code |
|---|---|
| Sadness | AABBccddklZPPQQWXYtuvv |
| Joy | pppqqqrrrssstttuuuvvvZZWWXXYYYnnooklccddaabb |
| Fear | KLefcccdddAAABBBPPPQQQZZZWWWXXXYYYYYtu |
| Surprise | KLefcccdddAABBPQZZWWWXXXYYYRStuvv |
| Disgust | CCCDDDAABBkklltttttuuuuuvvvRRSSZYXWno |
| Anger | CCCDDDklZZZWWWWXXXXYYYYYttuuvvab |

Table 6 shows the keyboard encoding of the Action Units of the Facial Action Coding System (the AUs relative to head orientation are not included). In the example below the eyes rotation is quantized in steps of 5 degrees and the joints translation is quantized in steps of 0.15 units.

The keyboard encoding method presents several advantages including: (1) Simplicity of user input requiring no additional input hardware (e.g. video cameras or motion capture devices); (2) Familiarity of the input method which requires no additional skills or learning time; (3) Accuracy: although the method uses a discretized representation of joints translation and eye rotation, the resolution of the quantization can be adjusted to configure the face with high precision; (4) Low bandwidth for storage and transmission: facial configuration/animation data can be stored in text files of minimum size, exported cross platform or transmitted via internet; (5) Easy extension to voice input.

There are some limitations to the method presented here. The first limitation is the restriction to a particular facial skeletal structure. White the method is applicable to any polygonal facial model rigged with a 22-joint skeleton, we have left to future developments the extension of the method to different facial skeletal setups.

Another limitation is the fact that the 22 regions discussed above, with relative deformations, need to be manually specified when the face is constructed. Future work involves the implementation of a method of automatically applying the 22 regions with relative deformations to any polygonal facial model. Such method would involve the development of a categorization of face models based on geometrical characteristics and skeletal structures.

[image]

Another limitation so far is the restriction to a static head and face. Although the model of the head can be dynamic while retaining the encoded facial expression, other expressions obtainable by re-orientation of the head are not included in the method. The motion/inclination of the head also conveys emotions, feelings and meaning.

The extension to include this motion in the interface is straightforward and is considered in example 4 where keyboard encoding of facial expressions and hand gestures are combined to provide a complete human body language representation.

Apart from these developments, future applications of the method can conceivably include client-server operation via the internet.

### EXAMPLE 5

American Sign Language (ASL) is a complete, complex language that employs signs made with the hands as well as other movements referred to as non-manual markers. Non-manual markers consist of various facial expressions, head tilting, shoulder raising, mouthing and similar signals added to the hand signs to create meaning. While it is possible to understand the meaning of an English sentence without seeing the facial expressions, this is less the case for ASL. In ASL, facial articulations are key components of grammar as they may carry semantic, prosodic, pragmatic, and syntactic information not provided by the manual signing itself. For example, speakers of English tend to inflect their voices to indicate they are asking a question. ASL signers inflect their questions by using non-manual markers. When signing a question that can be answered with “yes or no” the signer raises her eyebrows and tilts her head slightly forward. When signing a question involving “who, what, when, where, how, why” the signer furrows her eyebrows while tilting the head back a bit.

Research on facial expressions used in sign languages has been scattered with different groups addressing different aspects as they coincide with their specific needs (acquisition, syntactic structure, comparing signers to non-signers, etc.). Some studies on ASL facial articulation have focused on accurate identification of relevant positions and movements, some have concentrated on the meanings, functions, and interactions of these with each other and their influence on syntactic organization. However there is still an absence of clear information on ASL facial components which makes representing and teaching them a very difficult task.

In this embodiment we propose a new set of facial parameters for configuration and animation of any significant ASL facial expression of a avatar (see 0022 and below). An efficient parameterized facial model for modeling and animation of ASL facial components has direct applications to automatic sign language recognition and translation (e.g., deaf-computer interaction or deaf-hearing communication through automatic translation), and to classroom signing used in the education of deaf children.

The determination of our set of parameters is based on: (1) Adamo-Villani & Beni's (Adamo-Villani, N. & Beni, G. “Keyboard Encoding of Hand Gestures”. Proceedings of HCI International—10th International Conference on Human-Computer Interaction, Crete, vol. 2, pp. 571-575, 2003) recent research results on keyboard encoding of facial expressions, (2) ongoing research by Wilbur & Martinez on development of an integrated perceptual-linguistic-computational model (IPLC) of ASL non manuals, (3) FACS (Facial Action Coding System, and (4) the AR Face Database, all of which are incorporated herein by reference.

We have divided the face into 4 regions (Head, Upper Face, Nose, Lower Face) and we have identified 16 articulators and their respective degrees of freedom (totaling 26), each one controlled by a letter key. Table 7 shows the list of face articulators and dofs mapped to the letters of the English alphabet.

TABLE 7

| Face | | | | | | |
|---|---|---|---|---|---|---|
| Region | Articulator | ty | tz | rx | ry | rz |
| Head | 1. Head | v | w | x | y | z |
| Upper | 2. Eyebrows(1) | b | | | | |
| Face | 3. Eybrows(2) | a | | | | |
| | 4. Eyelids (upper) | c | | | | |
| | 5. Eyelids (lower) | f | | | | |
| | 6. Eyegaze | | | D | e | |
| Nose | 7. Nose | g | | | | |
| Lower | 8. Cheeks | | h | | | |
| Face | 9. Upper Lips(1) | j | | | | |
| | 10. Upper Lips(2) | k | | | | |
| | 11. Upper lips(3) | l | | | | |
| | 12. Lower Lips(1) | p | | | | |
| | 13. Lower Lips(2) | q | | | | |
| | 14. Lower Lips(3) | r | | | | |
| | 15. Tongue | n | o | | | |
| | 16. Chin | s | t | | | |

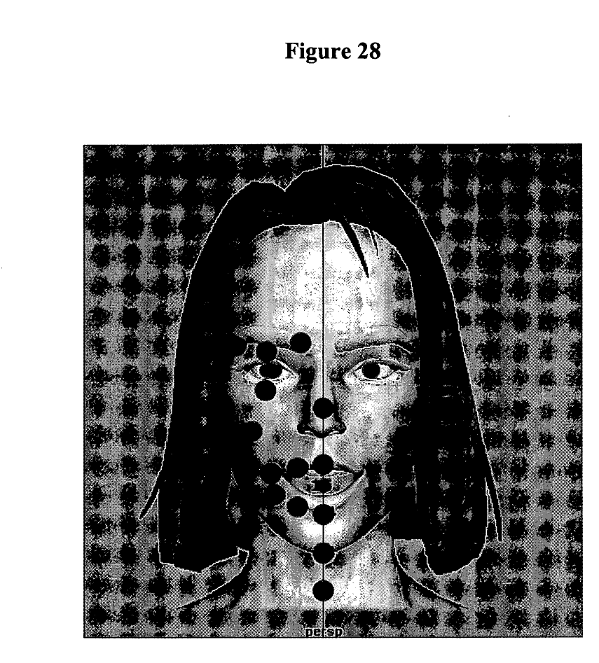

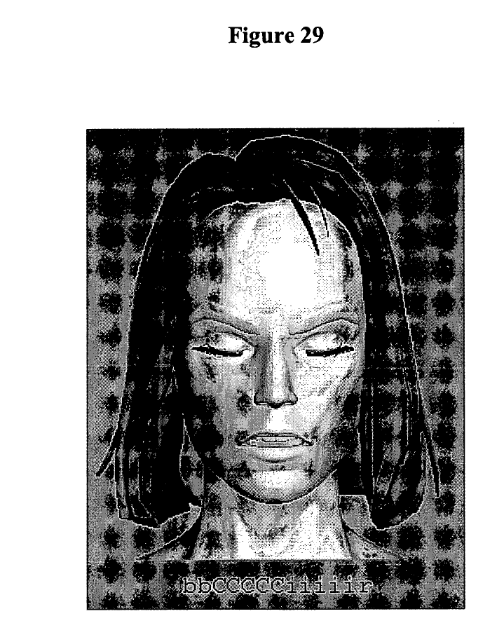

Each articulator is represented by a joint. The facial deformations induced by the articulators are obtained from rotation/translation of the joints. Each keystroke produces a quantized rotation/translation of the respective joint/articulator and the quantum of rotation/translation can be adjusted to increase or decrease the precision of the facial configuration. FIG. 28 shows the location of the joints corresponding to the 16 articulators. FIG. 29 shows an example of facial deformation induced by articulator 2, letter key b (frown), articulator 4, letter key C (blink), articulator 9, letter key I (downward motion of the corners of the mouth), and articulator 14, letter key r (mouth opening).

The HCI has been modified and extended to allow the control of both hands, head motion and facial expression.

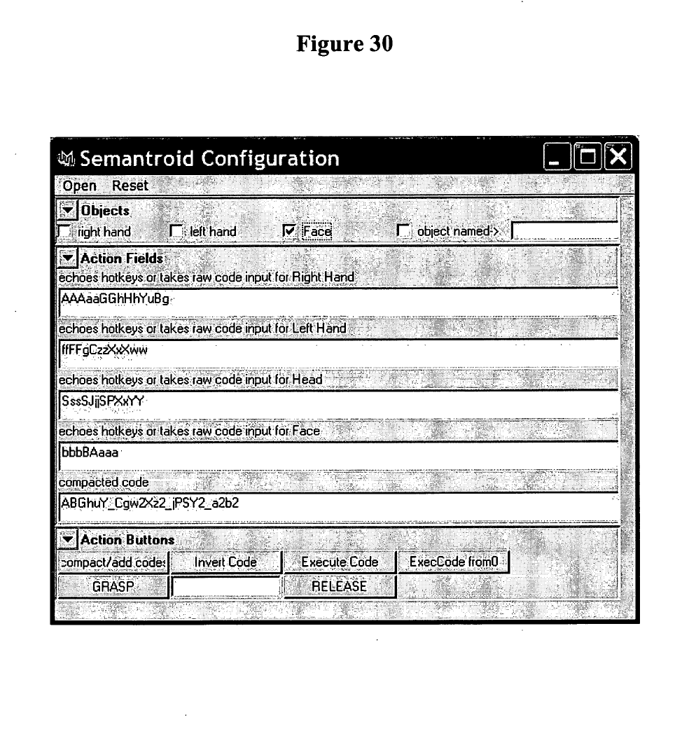

The Configuration window (FIG. 30) has three collapsible frame layouts: (1) the “Objects” frame; (2) the “Action Fields” frame; and (3) the “Action Buttons” frame.

The upper frame is used to select the objects on which KUI actions are performed. The two menus above the frame are used to open other two windows and to return the hands and face to their neutral positions. The menu items operate on the four different components of the avatar according to the status of the checkboxes. In the figure, the face box is checked for illustration. In such a case the operations apply only to the left part of the face. More precisely, the control is divided into four components: (1) right hand, (2) left hand, (3) head and right side (or symmetric motion) of the face, (4) left side of the face. The control of these four components is selected according to the checkboxes, as labeled. When no box is checked component (3), i.e. head and right face, is controlled. The last checkbox refers to the object to be grasped. Grasp action is not described here since it is identical to ref.

Avatars are used in many applications, where they are usually represented as complete human figures. This is functionally costly for 3D animation (modeling, rigging, rendering, etc.). Simplification would be desirable. We have shown that, contrary to intuition, an avatar can be simplified and, at the same time, convey more meaning.

Simplification of an avatar can be done at the expense of realism, e.g., by using a stick figure. Any simplification will result in two basic changes: (1) in the emotional content, and (2) in the semantic content of the avatar's message. Thus, to evaluate a simplification, it is necessary to have a measure of emotional content and semantic content. The former is very subjective and will not be considered here except for the following hypothesis: facial and hand gestures are the dominant actions conveying emotions in an avatar; hence, representation by only head and hands is capable of conveying the emotional content of an avatar's message.

What we will prove here is that the semantic content of an avatar's message is conveyed better by limiting the avatar to only head and hands.

Returning to the interface, the middle frame consists of five fields: the upper four fields echo the hotkeys used to configure the respective component (they can also be used to type in code in any form, raw or compacted, sorted or not); the lower field contains compacted code (that is code that is in the standard form, as described below). The hotkey input is echoed in the field corresponding to the object selected by the checkbox method as described previously. In FIG. 30 all four components have been configured. The snapshot (FIG. 30) refers to the configuration of the left side of the face (box ‘Face’ checked). The other components are assumed to have been previously configured. The last field of the middle frame contains the combined compacted code of the avatar configuration. The compaction method is as described above in Example 1. The compacted codes referring to the four avatar components are then combined by separating them with an underscore. The order is: right hand, left hand, head and right face, left face. In this way a single string describes the complete avatar configuration.

The third frame contains six buttons and a text field. The upper-row buttons perform the following actions (from left to right) (1) The first button compacts the code from the upper four fields and writes it in the lower field. If code is present in the upper fields and the lowest field, then the codes are added together. This operation is useful when planning animation steps. (2) The second button inverts the code written in the lower field. This is useful to retrace steps in planning animation. (3) The third button executes the compacted code in the lower field (the avatar will reconfigure itself accordingly and the reconfiguration is relative to the current position/orientation. (4) The fourth button operates as the upper-middle button but executes the code from the neutral position at the origin and applies only to the avatar (and not to the object to be grasped which would be irrelevant). The lower row buttons perform grasp and release actions on the object written in the text field. Grasp action has not been extended yet to the left hand, which will be the subject of future work.

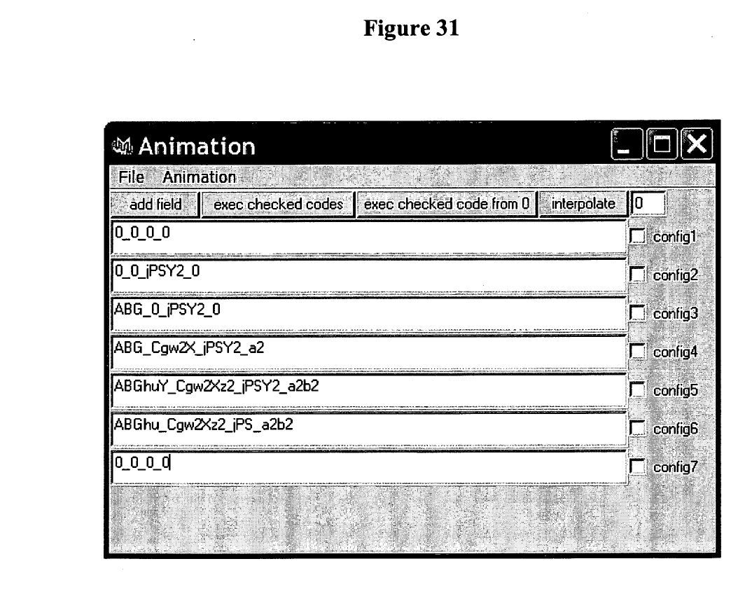

The “Animation” window (FIG. 31) is opened by the “Animation” submenu of the Configuration window, menu “Open.” The window “Animation” consists of “File” and “Animation” menus, four buttons and an arbitrary number of text fields followed by a checkbox.

Each text field is used to write one avatar configuration code, typically cutting and pasting from other files or the Configuration window but also by directly reading a text file in which configuration codes have been saved. The role of the “File” menu items is related to this and it is as in ref (Adamo-Villani, N. & Beni, G. “Grasp and Release using Keyboard User Interface”. Proceedings of IMG04—International Conference on Intelligent Manipulation and Grasping, Genova, Italy, 2004.

From left to right, the first button is used to create additional text fields with the corresponding checkbox. The second button executes the code for the field with its corresponding box checked. If more than one box is checked the configurations are ‘added’ from top to bottom field. ‘Adding’ two configurations means that the second code is executed starting from the configuration of the first code (instead of starting from the neutral configuration). This is particularly useful in correcting and/or refining avatar configurations. The third button operates as the second but executes the codes from the neutral positions at the origin. The fourth button generates interpolated codes from two codes written in the first and last field. The operation of interpolation is as described in ref (Adamo-Villani, N. & Beni, G. “A new method of hand gesture configuration and animation”. Journal of INFORMATION, 7 (3), 2004). Typically, after refining the avatar configurations created by hotkeys and recorded by the Configuration window, the codes are written sequentially in the “Animation” window and keyframed individually at chosen times to produce the desired animation. FIG. 31 illustrates a case in which starting from the neutral position, first the head and face are animated, then the motion of the right hand is added, and then follow three configurations where all four components are animated. Finally the avatar returns to the neutral position.

To show the efficiency of the keyboard-controlled avatar we provide an example of animation of the ASL sentence:
“½+⅓=?
Answer: ⅚”

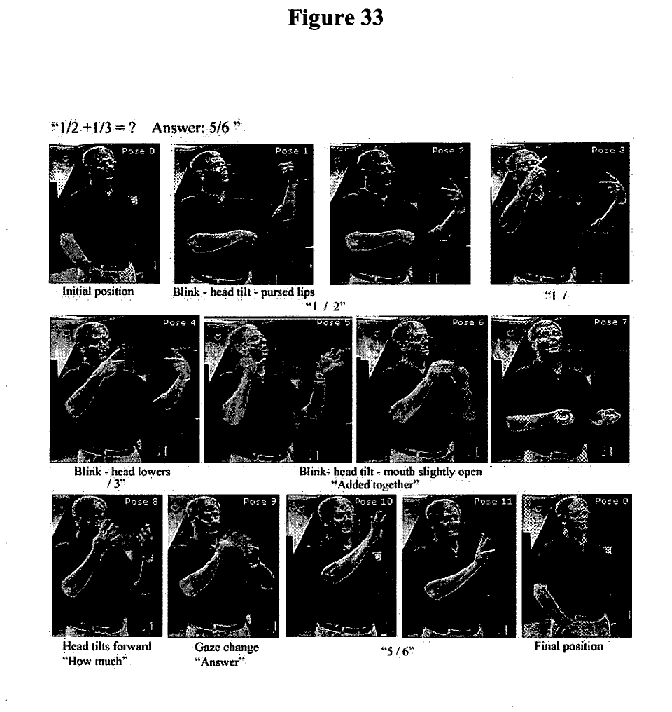

FIG. 33 contains still frames (poses 0-11) extracted from a video showing an ASL signer producing the above sentence. The concepts of “½ and ⅓” are signed first, followed by the concept of “addition,” then “how much” and finally the “answer.” The stills were extracted from the video each time a potentially meaningful change in manual and/or non-manual articulators was observed.

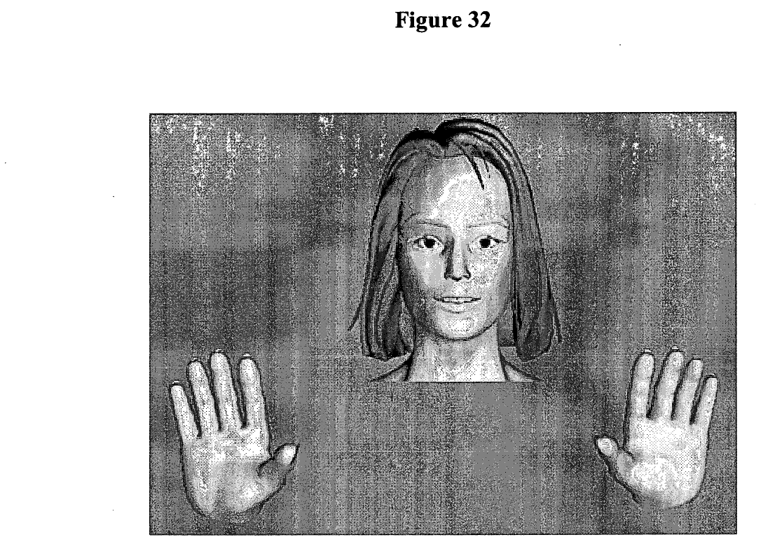

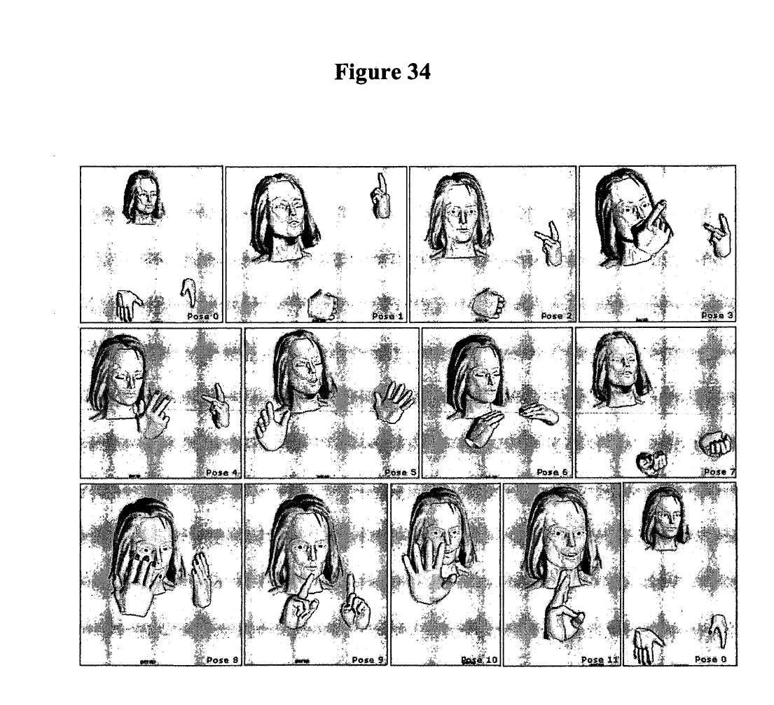

FIG. 34 shows the same frames extracted from the animation of the keyboard-controlled avatar signing the same ASL sentence. Table 7 shows the keyboard encoding of the avatar configuration for each pose. The codes are relative to the neutral position of the avatar (represented in FIG. 32). The finger joints pitch motion is quantized in steps of 10 degrees; the finger joint yaw motion is quantized in steps of 5 degrees; the wrist rotations are quantized in steps of 20 degrees and the wrist translations in steps of 1 cm. The translation of the facial joints is quantized in steps of 0.2 cm, the rotation of the head joint is quantized in steps of 15 degrees and the rotation of the eyes is quantized in steps of 5 degrees.

TABLE 8

| Pose | configuration |
|---|---|
| Pose 0 | v2w8Y6_v4w8y6_0_0 |
| Pose 1 | a7b2cf8g7Hi7j5k7l2m6_a7b7c3Fi3j10k3m2n10_w_C5J4 |
| Pose 2 | a7b2cf8g7Hi7j5k7l2m6_a12b5c2DhLm4n8o5q6r9s5v6y5_0_Id |
| Pose 3 | a6b3c2i4j9k6l2m6n8o6q5r10s5U2v7w2xy8_a12b5c2DhLm4n8o5q6r9s5v6y5_Vw_CD8E5I2 |
| Pose 4 | h2m3n7o8q4r7s8Uv9x6y2_a12b5c2DhLm4n8o5q6r9s5v6y5_W_C5 |
| Pose 5 | hPTUv2_hTv4W_w_C5J3S |
| Pose 6 | abcfgHjknorstv6w4_A8b4c5D2gH2kos3t2v5w3x7y2_0_C5 |
| Pose 7 | a6b4C12Ef6g4Hl2j5k5l2n5o5r5s5Uv9W5_a13c5f4g2j3k2l2n2o2pr2s4tv9W3X6y4_w_C5J4 |
| Pose 8 | v8x7y2_A3v9X4y2z2_W_0 |
| Pose 9 | a4c3D2i2j11k4l2m2n10o5q7r8s5v4wx7y2_a15b5cF2gi8j10k4m7n9o4q7r9s4v5_0_CdE4 |
| Pose 10 | hIPT2x6y5_v4w8y6_0_D5E12SC |
| Pose 11 | a7b3c2oq2r3s5v3x5_v4w8y6_0_D5EI2SC |

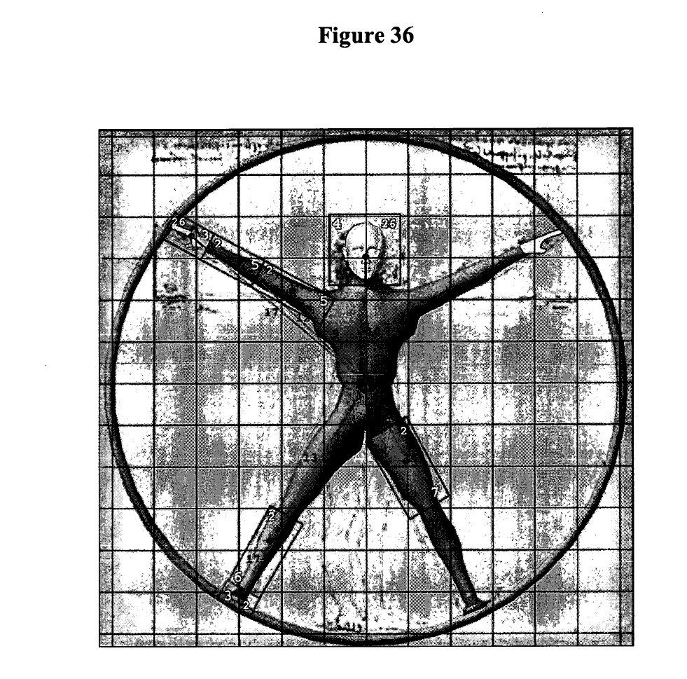

Consider the avatar of FIG. 36. The avatar is divided in the major human components. The semantic components are enclosed in blue rectangles. The average distance Dᵢ from the screen center to the ‘mass’ center of the i-th component is measured along the lines.

We consider the following quantities: (1) the ‘discerning effort’ Eᵢ, (2) the ‘meaning’ Mᵢ, (3) the number of ‘degrees of freedom’ Cᵢ, (4) the ‘average apparent (=the projected average distance on the screen) distance’ dᵢ, and (5) the ‘average apparent size’ sᵢ of the i-th component. Clearly, Dᵢ/Sᵢ=dᵢ/sᵢ.

The semantic intensity is defined as:

$$Ξ = \frac{{\sum }_{i} {M}_{i}}{{\sum }_{i} {E}_{i}} \qquad [ A1 ]$$

Given a segmentation of a 2D image in N objects J(i) (i=1, 2 . . . N), the general, intuitive idea of semantic intensity is based on the assumptions: (1) that each component object carries some meaning Mᵢ and that to perceive such meaning requires an effort Eᵢ; (2) that measures for Mᵢ and Eᵢ can be found. With these two assumptions, the semantic intensity [symbol] can be defined as the ratio of the total meaning conveyed by the objects to the total effort made by the perceiver.

$$Ξ = \frac{{\sum }_{i} {M}_{i}}{{\sum }_{i} {E}_{i}} \qquad [ A1 ]$$

Assumption (2) requires establishing measures of ‘meaning’ and ‘effort of perception of meaning.’ Rigorous measures of Mᵢ and Eᵢ can be investigated (Adamo-Villani & Beni, in preparation.

For Mᵢ we do not consider the information contained in the Jᵢ object itself but only the information contained in its possible variations during the animation. The number of possible variations scales with the number of degrees of freedom of Jᵢ for the motion of the avatar. Hence we take simply
Mᵢ=γCᵢ [A2]
Where γ is a constant. [Alternatively, we could have chosen the more plausible Mᵢ=γ log₂ Cᵢ but the qualitative results will not be affected.]

More intriguing is the measure of Eᵢ since perception ‘effort’ is not (unlike meaning and information) a well established concept. In analogy with the problem of measuring the difficulty of positioning a mouse on an object, it is plausible to consider the effort of positioning the eye on the object as having a similar dependence on the geometry of the object and its relation to the image. Such dependence, in the case of the reaction time in positioning a mouse on an object is given, e.g., by Fitts' law (Fitts, 1954). We make then the assumption that the effort of perceiving the object Jᵢ follows the law
Eᵢ=kᵢ+k₂ log₂ (Dᵢ/Sᵢ+1) [A3]
where k₁ and k₂ are two empirical parameters.

We estimate k₁ and the ratio k₁/k₂ as follows. From [A3], the parameter k₁ measures the effort at distance 0 from the screen center (assumed to be the rest position of the eye). There must be an effort even at distance zero; we assume that this effort is the effort of scanning the object which we may take to be proportional to its area, which in turn, we can take to scale as the square of the size, Sᵢ². Note that this is not the case for Fitts' law applied to the time it takes the mouse to reach a target. In such a case there is no time cost in scanning the target.

Again from [A3] it can be seen that the parameter k₂ measures the effort at distance Dᵢ=Sᵢ from the center. The area to be scanned at this distance is (approximately) proportional to 4aᵢ. Thus we may estimate the ratio
k₂/k₁₌3 [A4]
‘Rules of thumb’ for these constants for the ‘mouse on object’ case also estimate the value k₁/k₂₌3 (Raskin, 2000).

To estimate the semantic intensity [symbol] ₛ of a avatar with only hands and a head vs. the semantic intensity [symbol] ₐ of the avatar with a full body from which the avatar is derived we refer to a standard character which approximates a typical avatar (FIG. 36). The significant measures of this model are listed in Table 9. The number of degrees of freedom for the head and hand (26) are estimated from recent work on keyboard control of face and hand gestures. (see, e.g., Adamo-Villani and Beni, 2004)

TABLE 9
Parameters used for Eᵢ and Mᵢ: k₁ᵢ = Sᵢ²; k₂ᵢ/k_{1i =} 3; γᵢ = 1

| COMPONENT | SIZE | DISTANCE | EFFORT | MEANING |
|---|---|---|---|---|
| Jᵢ | Sᵢ | Dᵢ | Eᵢ | Mᵢ |
| Head | 4 | 10 | 102.8 | 26 |
| Hand | 3 | 17 | 82.9 | 26 |
| Arm | 5 | 9 | 136.4 | 2 |
| Forearm | 5 | 12 | 157.4 | 2 |
| Trunk | 10 | 0 | 100 | 2 |
| Thigh | 7 | 6 | 180.3 | 2 |
| Leg | 6 | 13 | 215.6 | 2 |
| Foot | 3 | 17 | 82.9 | 2 |
| Avatar total | | | 1913.8 | 90 |
| Avatar with only | | | 268.6 | 78 |
| head and hands | | | | |

From Table 9 the ratio of semantic intensities turns out to be [symbol]
ₛ/ [symbol] ₐ=6.2 [A5]

The analysis above is for 2D images. Since an avatar is typically a 3D model, in such a case its 3D measured lengths Dᵢ and Sᵢ should be averaged over the projections on the plane of the screen. These averaging results in a constant scaling factor, hence it does not affect the ratio Dᵢ/Sᵢ and thus has no effect on Eᵢ.

The analysis above concludes, in so far as conveying meaning to the viewer, that an avatar with only a head and hands are preferable to whole avatars.

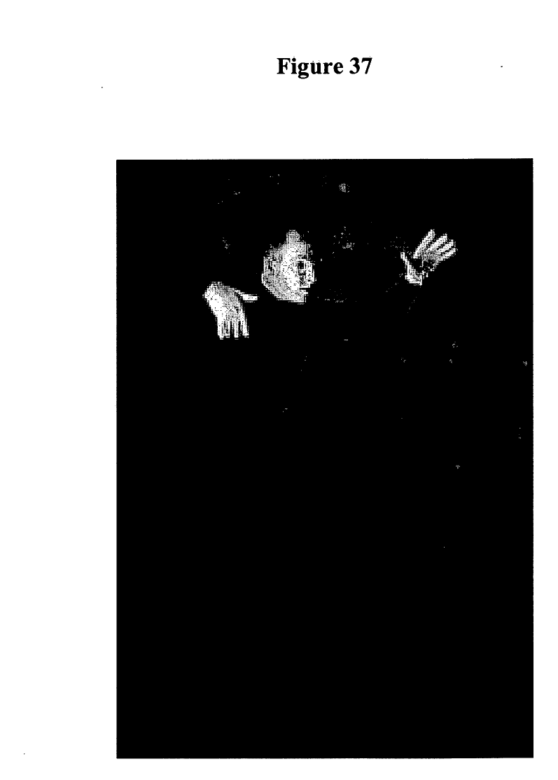

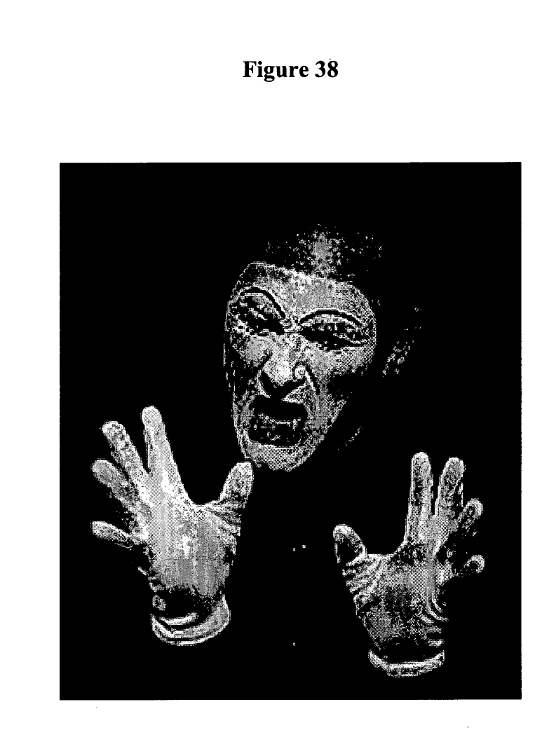

To see if this result makes sense it is interesting to look at intuitive notions. FIGS. 37 and 38 illustrate the intuitive notion that an avatar with only hands and a head contains most of the meaning in the message conveyed by a character.

It is therefore intended that the foregoing detailed description be regarded as illustrative rather than limiting, and that it be understood that it is the following claims, including all equivalents, that are intended to define the spirit and scope of this invention.

What is claimed is:

1. A method of configuring a three-dimensional model using a keyboard, the method comprising:
providing a three-dimensional model that is configurable about a plurality of degrees of freedom, where each respective degree of freedom is associated with a value representing a magnitude of movement from a neutral position;
associating at least one key on a keyboard with each respective degree of freedom of the three-dimensional model; and
in response to a selection of at least one key on the keyboard, identifying the respective degree of freedom associated with the keyboard selection and adjusting the value associated with the identified degree of freedom.

2. The method of claim 1, where the value associated with the identified degree of freedom is adjusted by a predetermined step size in response to the keyboard selection.

3. The method of claim 2, where each degree of freedom is associated with a respective predetermined step size.

4. The method of claim 2, where the three-dimensional model is configurable about less than 100 degrees of freedom.

5. The method of claim 2, where the three-dimensional model is configurable about less than 30 degrees of freedom.

6. The method of claim 1, where each respective degree of freedom is associated with a single key on the keyboard.

7. The method of claim 1, further comprising storing the three-dimensional model in a data structure, where the three-dimension model is represented by an alphanumeric string.

8. The method of claim 7, where the alphanumeric string is less than 100 characters.

9. The method of claim 7, where each letter in the alphanumeric string represents a respective degree of freedom in the three-dimensional model.

10. The method of claim 9, where each letter in the alphanumeric string is associated with a number, the number representing a magnitude of movement of a respective degree of freedom from a neutral position.

11. A computer-readable medium having computer-executable instructions for performing a method comprising:
maintaining a data structure including a plurality of elements, where each of the elements represents a degree of freedom associated with movement of either a hand or a face and where each of the elements is associated with a value representing a magnitude of movement from a neutral position;
associating each respective element with at least one key on a keyboard; and
in response to the selection of at least one key on the keyboard, identifying the element associated with the keyboard selection and adjusting the value associated with the identified element.

12. The computer readable medium of claim 11, where the value of the identified element is adjusted by a predetermined step size in response to the keyboard selection.

13. The computer readable medium of claim 11, where each respective element is associated with a single key on the keyboard.

14. The computer readable medium of claim 11, where the data structure includes less than 30 elements.

15. The computer readable medium of claim 14, where the data structure includes 26 elements.

16. The computer readable medium of claim 14, where the value of the identified element is adjusted based on the case of the at least one key on the keyboard.

17. A computer system comprising:
a processor;
a keyboard coupled to the processor; and
memory coupled to the processor, the memory comprising one or more sequences of instructions for building a hand configuration, wherein execution of the one or more sequences of instructions by the processor causes the processor to perform the steps of:
maintaining a data structure including a plurality of elements, where each of the elements represents a degree of freedom of a finger joint and where each of the elements is associated with a value representing a magnitude of movement from a neutral position;
associating at least one key on the keyboard with each of the elements; and
in response to the selection of at least one key on the keyboard, identifying the element associated with the keyboard selection and adjusting the value associated the identified element.

18. The computer system of claim 17, where the value of the identified element is adjusted by a predetermined step size in response to the keyboard selection.

19. The computer system of claim 17, where the predetermined step size is less than approximately ten degrees of movement.

20. The computer system of claim 17, where a portion of the elements represents a pitch motion associated with a finger joint and where a portion of the elements represents a yaw motion associated with a finger joint.

21. The computer system of claim 20, where the predetermined step size for the portion of elements representing the pitch motion associated with a finger joint is greater than the predetermined step size for the portion of elements representing the yaw motion associated with a finger joint.

22. The computer system of claim 17, where the data structure includes elements representing a degree of freedom of a wrist joint.

23. The computer system of claim 22, where the elements representing a degree of freedom of a wrist joint includes a portion of elements representing rotation of a wrist joint and a portion of elements representing translation of a wrist joint.

24. The computer system of claim 17, where the keyboard is substantially hand-shaped.

25. The computer system of claim 17, where the keyboard includes a key layout that is shaped like a hand.

26. The computer system of claim 25, where the key layout is configured such that a key approximately corresponds to each movable joint on a hand.

27. A method of forming a pose of a hand or face on a computer system, said method comprising:
providing a model of a hand or face that is configurable about a plurality degrees of freedom, where each respective degree of freedom is associated with a value representing a magnitude of movement from a neutral position;
associating at least one key on a keyboard with each respective degree of freedom of the model; and
in response to the selection of at least one key on the keyboard, identifying the degree of freedom associated with the keyboard selection and adjusting the value associated with the identified degree of freedom by a predetermined step size.

28. The method of claim 27, where in the associating step a single key on the keyboard is associated with each respective degree of freedom.

29. The method of claim 27, where the value associated with the identified degree of freedom is adjusted based on the case of a letter included in the keyboard selection.

30. The method of claim 29, where the value associated with the identified degree of freedom is incremented if the keyboard selection includes a lower case letter.

31. The method of claim 30, where the value associated with the identified degree of freedom is reduced if the keyboard selection includes an upper case letter.

32. The method of claim 27, where each degree of freedom is associated with a respective predetermined step size.

33. The method of claim 27, where the model is configurable about less than 30 degrees of freedom.

34. The method of claim 27, where each respective degree of freedom is associated with a single key on the keyboard.

35. The method of claim 27, further comprising storing the model in a data structure, where the model is represented by an alphanumeric string.

36. The method of claim 35, where the alphanumeric string is less than 100 characters.

37. The method of claim 36, where each letter in the alphanumeric string represents a respective degree of freedom in the model.

38. The method of claim 37, where each letter in the alphanumeric string is associated with a number, the number representing a magnitude of movement of a respective degree of freedom from a neutral position.

39. A computer-readable medium having stored thereon a data structure comprising:
a first element containing first identification data and first position data, where the first identification data associates the first element with a first degree of freedom of a hand and the first position data represents a magnitude of movement of the first degree of freedom from a neutral position; and
a second element containing second identification data and second position data, where the second identification data associates the second element with a second degree of freedom of a hand and the second position data represents a magnitude of movement of the second degree of freedom from a neutral position.

40. The computer-readable medium of claim 39, where the first identification data and the first position data consist of an alphanumeric sequence.

41. The computer-readable medium of claim 39, where the first identification data is a single character.

42. The computer-readable medium of claim 41, where the first identification data is a letter.

43. The computer-readable medium of claim 42, where the first identification data is a lower case letter, the first degree of freedom is directed in a first direction.

44. The computer-readable medium of claim 43, where the first identification data is an upper case letter, the first degree of freedom is directed in a second direction.

45. The computer-readable medium of claim 42, where the first position data is a number.

46. The computer-readable medium of claim 39, further comprising a third element containing third identification data and third position data, where the third identification data associates the third element with third degree of freedom of a face and the third position data represents a magnitude of movement of the third degree of freedom from a neutral position.

47. A computer-readable medium having stored thereon a data structure comprising:
a plurality of keyframes representing an animation of a sign language communication sequence, each respective keyframe containing expression data and animation time data, where the expression data represents a pose of a hand and where the first animation time data represents a length of time for displaying the expression data, and
where each keyframe is an alphanumeric string.

48. The computer-readable medium of claim 47, where each keyframe is less than 100 characters in length.

49. The computer-readable medium of claim 48, where the expression data represents a pose of a facial expression.

50. The computer-readable medium of claim 48, where the expression data of each keyframe consists of an alphanumeric string representing a pose of a facial expression and a pose of at least one hand.

51. The computer-readable medium of claim 48, where the sign language communication sequence relates to a mathematical lesson.

52. A method of controlling a robotic hand, the method comprising:
providing a robotic hand that is drivable about a plurality of degrees of freedom;
associating at least one key on a keyboard with each respective degree of freedom of the robotic hand; and
in response to a selection of at least one key on the keyboard, identifying the respective degree of freedom associated with the keyboard selection and driving the robotic hand about the identified degree of freedom.

53. The method of claim 52, where the identified degree of freedom is driven a predetermined angular step size in response to the keyboard selection.

54. The method of claim 52, further comprising associating at least one key with a grasping movement of the robotic hand.

55. The method of claim 52, further comprising associating at least one key with a release movement of a robotic hand.

56. A method of communicating in a non-verbal manner, the method comprising:
providing a library of sign language animation sequences, where at least one of the sign language animation sequences consists solely of hand gestures and facial expressions;
retrieving a signed language animation sequence from the library; and
displaying the retrieved sign language animation sequence on a display.
